(19) United States
(12) Patent Application Publication
(10) Pub. No.: US 2024/0283022 A1
(43) Pub. Date: Aug. 22, 2024

(54) GAS REDUCTION ADDITIVES FOR ELECTROCHEMICAL CELLS

(71) Applicant: Sion Power Corporation, Tucson, AZ (US)

(72) Inventors: Yuriy V. Mikhaylik, Tucson, AZ (US); Igor P. Kovalev, Vail, AZ (US); Alexis Sheffield, Tucson, AZ (US)

(73) Assignee: Sion Power Corporation, Tucson, AZ (US)

(21) Appl. No.: 18/414,928

(22) Filed: Jan. 17, 2024

Related U.S. Application Data
(60) Provisional application No. 63/439,827, filed on Jan. 18, 2023.

(51) Int. Cl. H01M 10/0567; H01M 4/02; H01M 4/38; H01M 10/0569; H01M 10/52

(52) U.S. Cl. CPC H01M 10/0567; H01M 4/382; H01M 10/0569; H01M 10/52; H01M 2004/027; H01M 2300/0034; H01M 2300/0037

(57) ABSTRACT

Treatment of electrode materials with poly(phosphate sulfate)s, and related articles and methods, are generally described. Some embodiments are associated with reduced gas generation during charge-discharge cycling of electrochemical cells. resulting from the treatment of the electrode materials.

This application claims priority to U.S. Provisional Application No. 63/439,827, filed Jan. 18, 2023, which is incorporated herein by reference in its entirety.

### TECHNICAL FIELD

Additives for electrochemical cells, including those for rechargeable batteries, are generally described.

### BACKGROUND

Some electrochemical cells such as high energy density rechargeable batteries have gleaned considerable attention in recent years. A common problem with such batteries is gas buildup during use. Gas generation in electrochemical cells presents a chronic safety hazard. Accordingly, articles and methods that would address these issues of safety and gas buildup in batteries would be beneficial.

### SUMMARY

Treatment of electrode materials with poly(phosphate sulfate)s, and related articles and methods, are generally described. Some embodiments are associated with reduced gas generation during charge-discharge cycling of electrochemical cells, resulting from the treatment of the electrode materials. The subject matter of the present disclosure involves, in some cases, interrelated products, alternative solutions to a particular problem, and/or a plurality of different uses of one or more systems and/or articles.

In one aspect, electrochemical cells are described. In some embodiments, the electrochemical cell comprises: an electrode comprising lithium; and an electrolyte, wherein the electrolyte comprises an organic solvent, a lithium salt, and a compound having a formula (I):

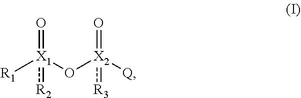

wherein X₁ [symbol] and X₂ [symbol] are each independently S [symbol] or P [symbol] , wherein R₁ is OH, O⁻, or OM, where M is Li⁺, Na⁺, or K⁺, wherein, when X₁ and/or X₂ is sulfur, R₂ and/or R₃ is O, respectively, wherein, when X₁ and/or X₂ is phosphorus, R₂ and/or R₃ is each independently OH, O⁻, or OM, where M is L⁺, Na⁺, or K⁺, respectively, and wherein Q is OH, O⁻, OM, where M is L⁺, Na⁺, or K⁺, or

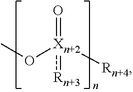

wherein n is an integer greater than or equal to 1 and less than or equal to 10, wherein each Xₙ₊₂ is independently sulfur or phosphorous, wherein when Xₙ₊₂ is sulfur, Xₙ₊₂ [symbol] is a double bond and Rₙ₊₃ is O, wherein when Xₙ₊₂ is phosphorus, Xₙ₊₂ [symbol] is a single bond and each Rₙ₊₃ is independently OH, O⁻, or OM, where M is Li⁺, Na⁺, or K⁺, and wherein Rₙ₊4 is independently OH, O⁻, or OM, where M is Li⁺, Na⁺, or K⁺.

In another aspect, electrodes are described. In some cases, the electrode comprises: a compound having a formula (I):

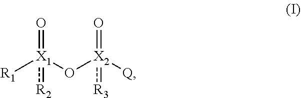

wherein X₁ [symbol] and X₂ [symbol] are each independently S [symbol] or P [symbol] , wherein R₁ is OH, O⁻, or OM, where M is Li⁺, Na⁺, or K⁺, wherein, when X₁ and/or X₂ is sulfur, R₂ and/or R₃ is O, respectively, wherein, when X₁ and/or X₂ is phosphorus, R₂ and/or R₃ is each independently OH, O⁻, or OM, where M is Li⁺, Na⁺, or K⁺, respectively, and wherein Q is OH, O⁻, OM, where M is Li⁺, Na⁺, or K⁺, or

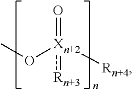

wherein n is an integer greater than or equal to 1 and less than or equal to 10, wherein each Xₙ₊₂ is independently sulfur or phosphorous, wherein when Xₙ₊₂ is sulfur, Xₙ₊₂ [symbol] is a double bond and Rₙ₊₃ is O, wherein when Xₙ₊₂ is phosphorus, Xₙ₊₂ [symbol] is a single bond and each Rₙ₊₃ is independently OH, O⁻, or OM, where M is Li⁺, Na⁺, or K⁺, wherein Rₙ₊₄ is independently OH, O⁻, or OM, where M is Li⁺, Na⁺, or K⁺, and wherein the electrode comprises lithium.

In another aspect, a method for treating an electrode is described. In some embodiments, the method of treating an electrode comprises: contacting at least a portion of an electrode active material comprising lithium with a compound having a formula (I):

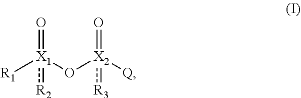

wherein X₁ [symbol] and X₂ [symbol] are each independently S [symbol] or P [symbol] , wherein R₁ is OH, O⁻, or OM, where M is Li⁺, Na⁺, or K⁺, wherein, when X₁ and/or X₂ is sulfur, R₂ and/or R₃ is O, respectively, wherein, when X₁ and/or X₂ is phosphorus, R₂ and/or R₃ is each independently OH, O⁻, or OM, where M is Li⁺, Na⁺, or K⁺, respectively, and wherein Q is OH, O⁻, OM, where M is Li⁺, Na⁺, or K⁺, or

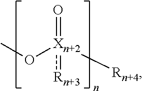

wherein n is an integer greater than or equal to 1 and less than or equal to 10, wherein each Xₙ₊₂ is independently sulfur or phosphorous, wherein when Xₙ₊₂ is sulfur, Xₙ₊₂ [symbol] is a double bond and Rₙ₊₃ is O, wherein when Xₙ₊₂ is phosphorus, Xₙ₊₂ [symbol] is a single bond and each Rₙ₊₃ is independently OH, O⁻, or OM, where M is Li⁺, Na⁺, or K⁺, and wherein Rₙ₊₄ is independently OH, O⁻, or OM, where M is Li⁺, Na⁺, or K⁺.

In another aspect, a method of treating an electrode of an electrochemical cell is described. In some embodiments, the method of treating an electrode of an electrochemical cell comprises: contacting an electrode comprising lithium with a compound present in the electrochemical cell, wherein the compound has a formula (I):

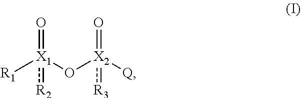

wherein X₁ [symbol] and X₂ [symbol] are each independently S [symbol] or P [symbol] , wherein R₁ is OH, O⁻, or OM, where M is Li⁺, Na⁺, or K⁺, wherein, when X₁ and/or X₂ is sulfur, R₂ and/or R₃ is O, respectively, wherein, when X₁ and/or X₂ is phosphorus, R₂ and/or R₃ is each independently OH, O⁻, or OM, where M is Li⁺, Na⁺, or K⁺, respectively, and wherein Q is OH, O⁻, OM, where M is Li⁺, Na⁺, or K⁺, or

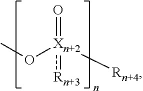

wherein n is an integer greater than or equal to 1 and less than or equal to 10, wherein each Xₙ₊₂ is independently sulfur or phosphorous, wherein when Xₙ₊₂ is sulfur, Xₙ₊₂ [symbol] is a double bond and Rₙ₊₃ is O, wherein when Xₙ₊₂ is phosphorus, Xₙ₊₂ [symbol] is a single bond and each Rₙ₊₃ is independently OH, O⁻, or OM, where M is Li⁺, Na⁺, or K⁺, and wherein Rₙ₊₄ is independently OH, O⁻, or OM, where M is Li⁺, Na⁺, or K⁺, the method further comprising releasing a gas produced by the contact between the electrode and the compound.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1A presents a schematic, cross-sectional illustration of an electrochemical cell, according to some embodiments;

FIGS. 1B-1C present schematic, cross-sectional illustrations of untreated and treated electrodes, according to some embodiments;

FIGS. 2A-2B present a schematic, cross-sectional illustration of a method of treating an electrode, according to some embodiments;

FIGS. 3A-3C present a schematic, cross-sectional illustration of a method of treating an electrode, according to some embodiments;

FIG. 4 presents a schematic, cross-sectional illustration of a method of treating an electrode, according to some embodiments; and

FIG. 5 presents a schematic, cross-sectional illustration of an electric vehicle comprising a battery, according to some embodiments.

### DETAILED DESCRIPTION

The present disclosure provides systems and methods for reducing gas generation in electrochemical cells. In some electrochemical cells, electrolyte degradation can result in the formation of gaseous by-products, also known as gassing, or gas generation. Gas generation, which often occurs during charge and/or discharge of an electrochemical cell, can cause a pressure buildup that can physically damage the electrochemical cell. Thus, gas generation can detrimentally limit the lifetime and usefulness of an electrochemical cell (or a battery comprising it), and can pose a physical and chemical hazard to users of the battery. The electrochemical cells, systems, and methods provided herein may reduce or eliminate gas generation in electrochemical cells without significantly interfering with electrochemical cell performance, according to some embodiments.

In some cases, electrochemical cells comprise an electrolyte comprising poly(phosphate sulfate)s, which may be a compound (e.g., a dimer, an oligomer, a polymer) comprising monomeric units of phosphates, sulfates, and/or their derivatives.

Exposing and/or treating an untreated electrode (e.g., in the electrochemical cell) with poly(phosphate sulfates) may result in a treated electrode. According to some embodiments, the treated electrode generates less gas upon cycling (e.g., relative to the untreated electrode) within the electrochemical cell. Without wishing to be bound by any particular theory, it is believed that poly(phosphate sulfate)s, when introduced into the electrolyte of the electrochemical cell, may react with the untreated electrode comprising impurities to form the treated electrode with fewer impurities (e.g., relative to the untreated electrode). In some such cases, the treated electrode generates less gas upon electrochemical cycling due to the presence of fewer impurities. In some embodiments, these advantages are brought through the use of one or more poly(phosphate sulfate)s to treat the electrode(s). As described in more detail below, a poly(phosphate sulfate)s may include a pure polysulfate, a pure polyphosphate, or a compound (e.g., a dimer, an oligomer, a polymer) including monomeric units of both phosphates and sulfates.

Gas generation may be a particular problem in the context of lithium ion cells. Accordingly, in some embodiments the configurations described herein pertain to lithium ion cells. It should be appreciated, however, that the embodiments described herein may be applied to, incorporated into, and/or used with other types of electrochemical cells.

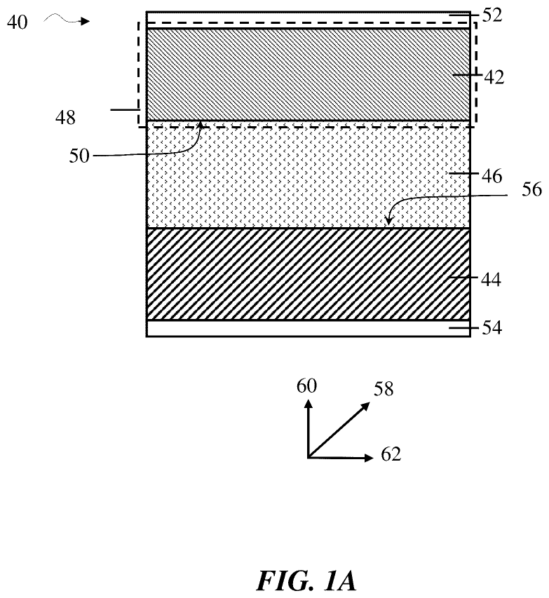

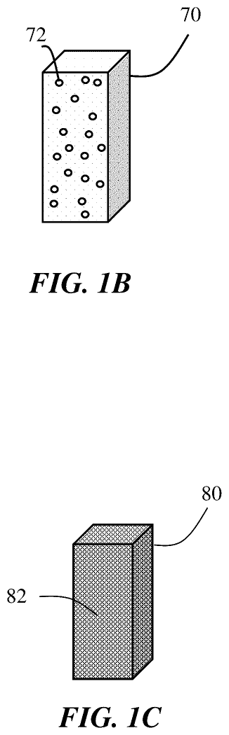

In one aspect, an electrochemical cell is provided. An electrochemical cell generally comprises an electrode and an electrolyte. An electrode may comprise an active material (e.g., an electroactive material), as discussed in greater detail below. In some embodiments, an electrode comprises lithium. The electrochemical cell itself may be a lithium ion cell, according to some embodiments. FIG. 1A provides a non-limiting schematic illustration of a cross-section of an electrochemical cell 40. As shown illustratively in FIG. 1A, an electrochemical cell 40 comprises a first electrode 42 (e.g., a cathode), an optional second electrode 44 (e.g., an anode), and an electrolyte 46 disposed between first electrode 42 and second electrode 44. The electrochemical cell may optionally include a separator disposed between the first electrode and the second electrode. In some embodiments, the separator comprises porous separator materials that contain a non-solid electrolyte (e.g., a liquid electrolyte). For example, referring to FIG. 1A, a porous separator (not shown) may be used to house electrolyte 46 and may be positioned between first electrode 42 and second electrode 44. Alternatively, in some embodiments, the electrolyte may be a solid state electrolyte or gel electrolyte that functions as a separator in addition to its electrolyte function. An electrochemical cell may further include one or more current collectors (e.g., current collectors 52 and 54 shown in FIG. 1A).

According to one aspect, poly(phosphate sulfate)s are used in electrochemical cells for the purpose of reducing or preventing gas generation within an electrochemical cell. Gas generation in electrochemical cells can depend, at least in part, on electrolyte composition. Without wishing to be bound by any particular theory, gas generation in electrochemical cells may occur as a result of a reaction of impurities at an electrode of an electrochemical cell. The gas generation may occur over time, e.g., during cycling of the electrochemical cell. Without wishing to be bound by any particular theory, it is believed that poly(phosphate sulfate)s may pre-emptively react with gas-generating impurities, allowing the impurities to be consumed, and allowing any resulting gas to be separated from the electrochemical cell prior to its use. As discussed below, a poly(phosphate sulfate) may be included in an electrode (e.g., electrode 42 of electrochemical cell 40 of FIG. 1A), or in an electrolyte (e.g., electrolyte 46 of electrochemical cell 40 of FIG. 1A).

A poly(phosphate sulfate) may be a compound (e.g., a dimer, an oligomer, a polymer) comprising monomeric units of phosphates or sulfates and their derivatives, according to some embodiments. For example, a poly(phosphate sulfate) may be a pure polysulfate, a pure polyphosphate, or a compound (e.g., a dimer, an oligomer, a polymer) comprising monomeric units of both phosphates and sulfates. According to some embodiments, a poly(phosphate sulfate) compound has a formula (I),

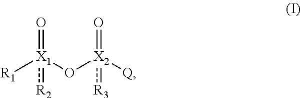

wherein X₁ [symbol] and X₂ [symbol] are each independently S [symbol] or P [symbol] . The group R₁ may be OH, O⁻, or OM, where M represents a metal ion. For example, in some embodiments, M is Li⁺, Na⁺, or K⁺. The groups R₂ and R₃, depending on the identity of the corresponding “X group” (e.g., R₂ may depend on the identity of X₂, R₃ may depend on the identity of X₃), may each independently be O, OH, O⁻, or OM, where M represents a metal ion (e.g., Li⁺, Na⁺, or K+). In some embodiments, when X₁ and/or X₂ is sulfur, R₂ and/or R₃ is O, respectively. In some cases, when X₁ and/or X₂ is phosphorus, R₂ and/or R₃ is each independently OH, O⁻, or OM, where M is Li⁺, Na⁺, or K⁺, respectively. In some embodiments, the group Q may terminate the compound, by being OH, O⁻, or OM, where M is a metal ion (e.g., Li⁺, Na⁺, or K+). In some such cases, the compound (I) is referred to herein as a poly(phosphate sulfate) dimer. Non-limiting examples of suitable poly(phosphate sulfate) dimers include pyrosulfate dimers and pyrophosphate dimers. Poly(phosphate sulfate) dimers may have a number of advantages for use in batteries, including their relatively high mobility within the electrolyte and their availability in a relatively high supply.

In some embodiments, the poly(phosphate sulfate) is longer than a dimer. For example, a compound may have the formula (I) above, wherein Q is

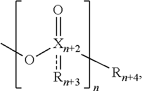

wherein n is an integer greater than or equal to 1 and less than or equal to 10. Like X₁ and X₂ discussed above, each Xₙ₊₂ is independently sulfur or phosphorous. As with R₁, R₂, and R₃ discussed above, when Xₙ₊₂ is sulfur, the group(s) denoted by Rₙ₊₃ is O and the corresponding bond denoted with [symbol] (e.g., when present, the bond between Xₙ₊₂ and Rₙ₊₃, the bond between Xₙ₊₃ and Rₙ₊₄, and so forth) is a double bond. In some cases, when Xₙ₊₂ is phosphorus, the group(s) denoted by Rₙ₊₃ may each independently be OH, O⁻, or OM, where M is a metal ion (e.g., Li⁺, Na⁺, or K⁺) and the corresponding bond(s) denoted with [symbol] is a single bond. Similarly, in some embodiments, Rₙ₊₄ is independently OH, O⁻, or OM, where M is a metal ion (e.g., Li⁺, Na⁺, or K⁺). In some embodiments, n is an integer greater than or equal to 1 and less than or equal to 10 (i.e., the poly(phosphate sulfate) comprises a backbone including greater than or equal to 3 total “X groups” (e.g., X₁, X₂, Xₙ₊₂) and less than or equal to 12 total “X-groups” that are each, independently phosphorous or sulfur atoms). In some cases, poly(phosphate sulfate)s longer than dimers may have advantages. For example, longer poly(phosphate sulfate)s generally include more X-groups in their backbone than poly(phosphate sulfate) dimers, meaning that the longer poly(phosphate sulfate)s may be subjected to multiple cleavage reactions (whereas a dimer backbone can only be cleaved once, according to some embodiments).

In some embodiments, a compound has the formula (I) wherein X₁ and X₂ are both sulfur. Similarly, a compound may have the formula (I) wherein X₁ and X₂ are both phosphorous. A compound having the formula (I) may be a salt. For example, the compound having the formula (I) may be a polysulfate salt (e.g., a pyrosulfate salt such as lithium pyrosulfate, sodium pyrosulfate, or potassium pyrosulfate), a polyphosphate salt (e.g., a pyrophosphate salt such as lithium pyrophosphate, sodium pyrophosphate, or potassium pyrophosphate), or a salt of a poly(phosphate sulfate) compound (e.g., a dimer, an oligomer, a polymer) comprising monomeric units of both phosphates and sulfates.

In one set of embodiments, an electrode comprising an impurity may be contacted with a poly(phosphate sulfate) (e.g., a compound having formula (I)) to form a treated electrode. For instance, consider FIG. 1B, which shows a schematic illustration of an electrode 70 comprising impurities 72. In some such cases, the impurities may render the electrode reactive and unstable. Non-limiting examples of impurities that may be associated with an electrode include Li₂CO₃, LiOH, Li₂O, NiO, Ni(OH)₂, and transition metal oxides, hydroxides, and oxyhydroxides. In some embodiments, reacting the impurities associated with an electrode with a poly(phosphate sulfate) may advantageously result in the formation of a treated electrode with enhanced chemical stability relative to an untreated electrode, all other factors being equal. For example, as described in more detail below, the presence of one or more impurities associated with an electrode may lead to undesired gas generation during cycling of the electrode in an electrochemical cell. Accordingly, as shown in an exemplary embodiment in FIG. 1C, reacting the impurities associated with the electrode with a poly(phosphate sulfate) may produce a treated electrode 80 comprising treated material 82 having fewer impurities (e.g., relative to the electrode 70 in FIG. 1B) that are capable of gas generation.

Prior to a reaction between an electrode and a poly(phosphate sulfate), impurities associated with the electrode may be present in the electrode in any of a variety of amounts, depending on the specific type of electrode used. For example, in some embodiments, an electrode (e.g., the electroactive material of an electrode) includes impurities in an amount of greater than or equal to 0 wt %, greater than or equal to 0.1 wt %, greater than or equal to 0.2 wt %, greater than or equal to 0.3 wt %, greater than or equal to 0.4 wt %, greater than or equal to 0.5 wt %, greater than or equal to 0.6 wt %, greater than or equal to 0.7 wt %, greater than or equal to 0.8 wt %, greater than or equal to 0.9 wt %, greater than or equal to 1.0 wt %, greater than or equal to 1.2 wt %, greater than or equal to 1.5 wt %, greater than or equal to 1.8 wt %, greater than or equal to 2.0 wt %, greater than or equal to 2.2 wt %, or greater than or equal to 2.5 wt %. In some embodiments, an electrode (e.g., the electroactive material of an electrode) includes impurities in an amount of less than or equal to 3.0 wt %, less than or equal to 2.8 wt %, less than or equal to 2.5 wt %, less than or equal to 2.2 wt %, less than or equal to 2.0 wt %, less than or equal to 1.8 wt %, less than or equal to 1.5 wt %, less than or equal to 1.2 wt %, less than or equal to 1.0 wt %, less than or equal to 0.9 wt %, less than or equal to 0.8 wt %, less than or equal to 0.7 wt %, less than or equal to 0.6 wt %, or less than or equal to 0.5 wt %. Combinations of these ranges are also possible (e.g., greater than or equal to 0 wt % and less than or equal to 3 wt %, greater than or equal to 0.1 wt % and less than or equal to 2.8 wt %, or greater than or equal to 0.2 wt % and less than or equal to 2.5 wt %). Other ranges are also possible.

Impurities may be associated with the electrode in any of a number of ways. Impurities may be in physical contact with an electrode. For example, in some embodiments, impurities are contained within the electrode and/or present on the external surface of the electrode.

In some embodiments, reacting impurities associated with an electrode comprises reacting “accessible impurities” associated with the electrode. The phrase “accessible impurities”, as used herein, refers to impurities associated with an electrode that can be contacted by a poly(phosphate sulfate) without removing the other components (e.g., electroactive materials) within the electrode. Accessible impurities include both impurities that are accessible by the poly(phosphate sulfate) prior to reacting impurities as well as impurities that are accessible after overlying impurities have been reacted and removed (e.g., reacted away). Accessible impurities would not include impurities completely surrounded by other components (e.g., electroactive materials) within the electrode, as the other components would need to be removed before the poly(phosphate sulfate) could access the surrounded impurities.

In some embodiments, a reaction of a poly(phosphate sulfate) compound with impurities associated with an electrode results in the formation of a gaseous byproduct. For example, the gaseous byproducts may include CO₂, O₂, SO₂, SO₃, COS, H₂S, H₂, or a combination thereof. An advantage of performing such a reaction is that, in some embodiments, these gaseous byproducts may be formed and released prior to cycling of an electrochemical cell comprising the electrode. In some embodiments, a substantially large amount of the accessible impurities associated with an electrode may be reacted and converted into gaseous byproducts. For example, in some embodiments, at least 15 wt % (e.g., at least 20 wt %, at least 25 wt %, at least 30 wt %, at least 40 wt %, at least 50 wt %, at least 60 wt %, at least 70 wt %, at least 80 wt %, at least 90 wt %, or all) of the accessible impurities associated with an electrode are reacted and converted into gaseous byproducts. In some embodiments, the above-mentioned percentages are associated with accessible impurities at one or more outer surfaces of the electrode. In some instances, these reactions may occur prior to cycling of the electrochemical cell including the treated electrode.

Any of a variety of methods may be used to treat an electrode using one of the compounds described herein. In some cases, electrode treatment occurs in situ. For example, a method of treating the electrode may comprise contacting the electrode with a compound present in an electrochemical cell. For example, a compound may be dissolved or suspended in an electrolyte of an electrochemical cell and may thus be placed in contact with the electrode(s) (e.g., electroactive materials) of the electrochemical cell. Referring again to FIG. 1A, the compound(s) may be included in electrolyte 46, for example. Gas generated by contact between the compound and the electrode may be released by venting the electrochemical cell. In some cases, the electrode may be cycled one or more times prior to venting of the cell, to facilitate electrode formation. However, the electrochemical cell need not be cycled prior to venting, and in some cases, venting is performed before any cycling of the electrochemical cell.

According to some embodiments, when treating an electrode by contacting the electrode with an electrolyte comprising a compound, the compound may be dissolved or suspended in the electrolyte in an amount of greater than or equal to 0.01 wt %, greater than or equal to 0.02 wt %, greater than or equal to 0.05 wt %, greater than or equal to 0.1 wt %, greater than or equal to 0.2 wt %, greater than or equal to 0.5 wt %, greater than or equal to 1 wt %, greater than or equal to 2 wt %, greater than or equal to 4 wt %, greater than or equal to 5 wt %, greater than or equal to 7 wt %, greater than or equal to 9 wt %, greater than or equal to 9.5 wt %, greater than or equal to 9.9 wt %, greater than or equal to 9.99 wt %, or greater than or equal to 10 wt %. In some cases, the compound is present in the electrolyte at less than or equal to 10 wt %, less than or equal to 9.99 wt %, less than or equal to 9.9 wt %, less than or equal to 9.5 wt %, less than or equal to 9 wt %, less than or equal to 7 wt %, less than or equal to 5 wt %, less than or equal to 4 wt %, less than or equal to 2 wt %, less than or equal to 1 wt %, less than or equal to 0.5 wt %, less than or equal to 0.2 wt %, less than or equal to 0.1 wt %, less than or equal to 0.05 wt %, less than or equal to 0.02 wt %, or less than or equal to 0.01 wt %. Combinations of the above-referenced ranges are also possible (e.g., greater than or equal to 2 wt % and less than or equal to 4 wt %). Other ranges are possible, as this disclosure is not so limited.

In some embodiments, the compound(s) is used to treat an electrode prior to introduction of the electrode into an electrochemical cell. In some cases, treatment occurs during formation of the electrode. In other cases, treatment may occur after the electrode has already been formed. Treatment may be performed by incorporating a compound described herein directly into the electrode (e.g., by mixing it with an electroactive material during formation of the electrode, or by infiltrating it into an already-formed electrode). An electrode treated in these ways may subsequently be assembled into an electrochemical cell. Reaction of the compound with the impurities of the electrode may be performed primarily within the assembled electrochemical cell or may be performed outside the electrochemical cell.

Various amounts of a compound are incorporated directly into an electrode to treat the electrode prior to introduction into an electrochemical cell, in accordance with some embodiments. In some cases, when forming the electrode, the compound may be incorporated at greater than or equal to 0.01 wt %, greater than or equal to 0.02 wt %, greater than or equal to 0.05 wt %, greater than or equal to 0.1 wt %, greater than or equal to 0.2 wt %, greater than or equal to 0.5 wt %, greater than or equal to 1 wt %, greater than or equal to 2 wt %, greater than or equal to 3 wt %, greater than or equal to 3.5 wt %, greater than or equal to 3.9 wt %, greater than or equal to 3.95 wt %, greater than or equal to 3.99 wt %, or greater than or equal to 4 wt %. In some cases, the compound may be incorporated into the electrode at less than or equal to 4 wt %, less than or equal to 3.99 wt %, less than or equal to 3.95 wt %, less than or equal to 3.9 wt %, less than or equal to 3.5 wt %, less than or equal to 3 wt %, less than or equal to 2 wt %, less than or equal to 1 wt %, less than or equal to 0.5 wt %, less than or equal to 0.2 wt %, less than or equal to 0.1 wt %, less than or equal to 0.05 wt %, less than or equal to 0.02 wt %, or less than or equal to 0.01 wt %. Combinations of the above-referenced ranges are also possible (greater than or equal to 0.1 wt % and less than or equal to 4 wt %). Other ranges are possible.

In some cases, no amount of a compound (i.e., 0 wt %) is incorporated into an electrode prior to introduction into an electrochemical cell. In some such cases, treatment of the electrode may proceed by the above-referenced contacting the electrode with electrolyte comprising the compound. Alternative embodiments are also considered, wherein treating the electrode may comprise only incorporating the compound into the electrode, prior to introducing the electrode into the electrochemical cell (e.g., wherein the electrolyte in the electrochemical cell comprises 0 wt % of the compound). Of course, it is also possible, in accordance with some embodiments, to treat the electrode by incorporating the compound into the electrode prior to introducing the electrode into the electrochemical cell and including the compound in the electrolyte of the electrochemical cell.

Various embodiments contemplated herein use a single compound to treat an electrode (e.g., prior to introducing the electrode to an electrochemical cell, when contacting the electrode with an electrolyte in an electrochemical cell). In some cases, multiple compounds are used to treat the electrode. Some embodiments use at least one compound to treat the electrode prior to introduction to the electrochemical cell and at least one compound to treat the electrode after introduction into the electrochemical cell. According to some such embodiments, the compound(s) used to treat the electrode before and after introduction of the electrode to the electrochemical cell may be different or the same. Appropriate compounds for treating electrodes are disclosed elsewhere herein.

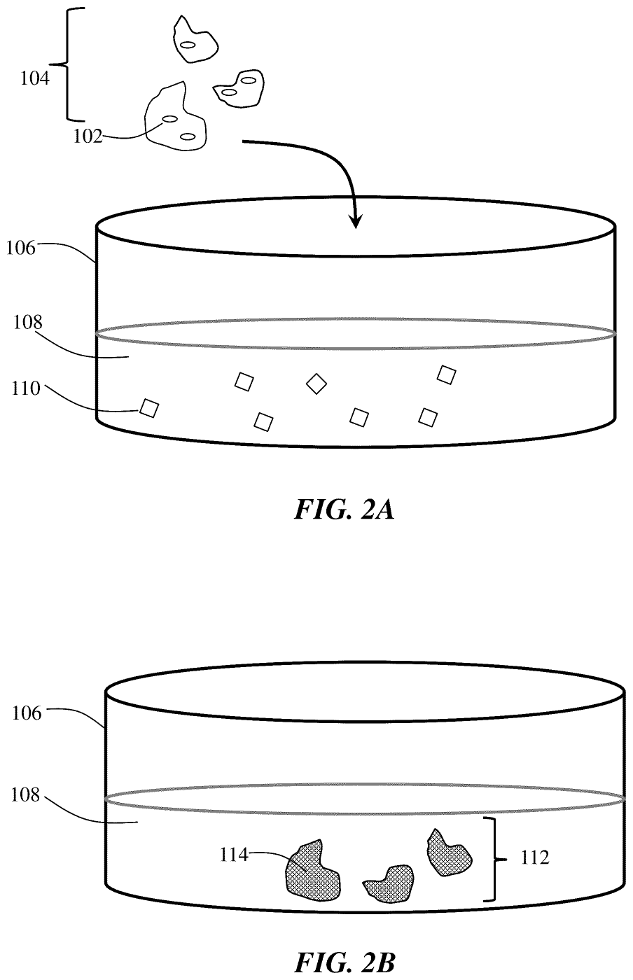

FIGS. 2A-4 illustrate various embodiments of producing a pre-treated electrode. FIGS. 2A-2B illustrate an example of the providing of an electrode material (e.g., an electroactive material) and the reacting of the electrode material and/or an impurity associated with the electrode material with a compound described herein (e.g., a poly(phosphate sulfate)). As shown illustratively in FIG. 2A, an electrode material (e.g., electroactive material) 104, with which impurities 102 may be associated, has been added to poly(phosphate sulfate) 110 contained in vessel 106 to form a reaction mixture. In some embodiments, the poly(phosphate sulfate) may be suspended or dissolved in an appropriate liquid carrier, e.g., to allow for an efficient contact between the electrode material and/or impurities associated with the electrode material and the poly(phosphate sulfate). As shown illustratively in FIG. 2A, poly(phosphate sulfate) 110 has been dissolved or suspended in liquid carrier 108. In some embodiments, the liquid carrier may be substantially inert, e.g., unreactive to the electrode material, impurities associated with the electrode material, and the poly(phosphate sulfate), such that the liquid carrier does not participate in and/or interfere with the reaction between the electrode material and/or impurities associated with the electrode material and the poly(phosphate sulfate). As shown illustratively in FIG. 2B, exposure of the impurities of the electrode material to the poly(phosphate sulfate) may result in the formation of a plurality of treated electrode material particles 112 including treated electrode material 114.

While FIGS. 2A-2B show a set of embodiments in which the electrode material is added to the poly(phosphate sulfate), it should be understood that not all embodiments described herein are so limiting, and in other embodiments, the order of addition is not so limited. The poly(phosphate sulfate) may be exposed to the electrode material in any appropriate fashion. For example, in some embodiments, the poly(phosphate sulfate) may be added to an electrode material that is suspended in a liquid carrier.

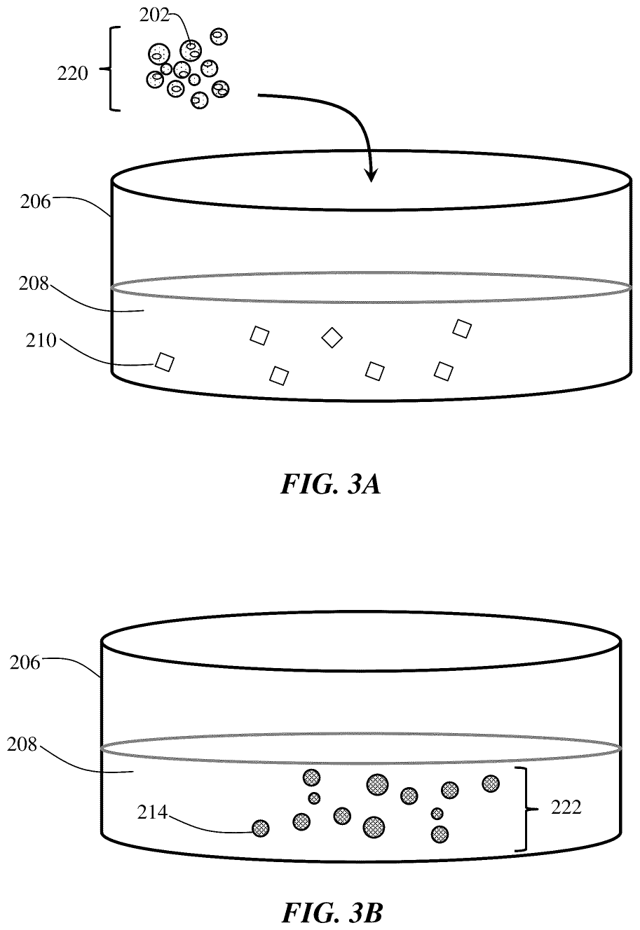

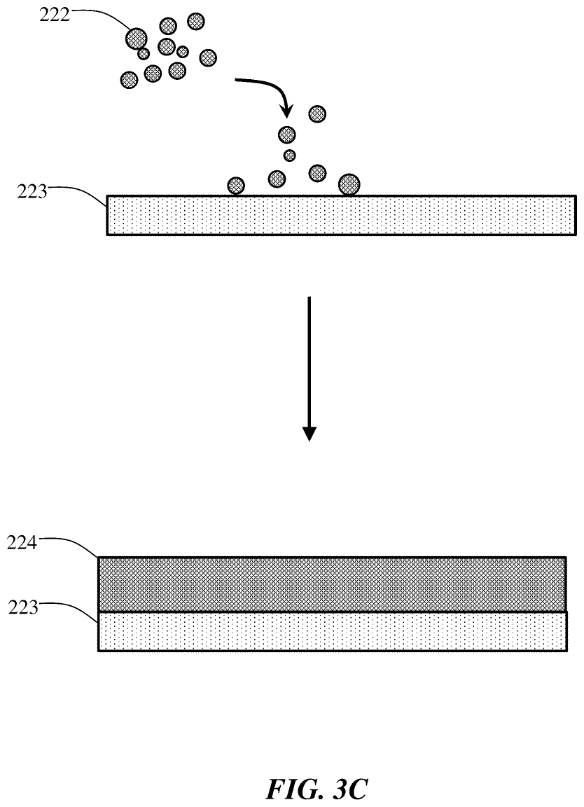

In one set of embodiments, the electrode material may comprise a plurality of electrode material particles (e.g., a powder of electroactive materials and any other binders, inert materials, and/or other functional materials intended for use in the final electrode), and the reacting comprises reacting the plurality of electrode material particles and/or impurities associated with the plurality of electrode material particles with the poly(phosphate sulfate). FIGS. 3A-3B illustrate an example of one such set of embodiments. As shown, a plurality of electrode material particles 220, comprising impurities 202, have been exposed to (e.g., added to, mixed with) poly(phosphate sulfate) 210 suspended or dissolved in liquid carrier 208. The suspended or dissolved poly(phosphate sulfate) 210 has reacted with electrode material particles 220 and/or impurities 202 associated with electrode material particles 220, forming a plurality of treated electrode material particles 222 including treated electrode material 214.

In some such embodiments, the treated electrode material may be dried and subsequently formed into an electrode (e.g., a cathode). FIG. 3C illustrates an example of one such set of embodiments. As shown, treated electrode material particles 222 can be deposited onto substrate 223 by any appropriated method described elsewhere herein to form electrode 224. For instance, the treated electrode material particles may be hand coated onto a substrate to form the electrode. In some embodiments, the formed electrode comprising treated electrode material particles may be subsequently used as a cathode in an electrochemical cell. The treated electrode may comprise at least some of the poly(phosphate sulfate).

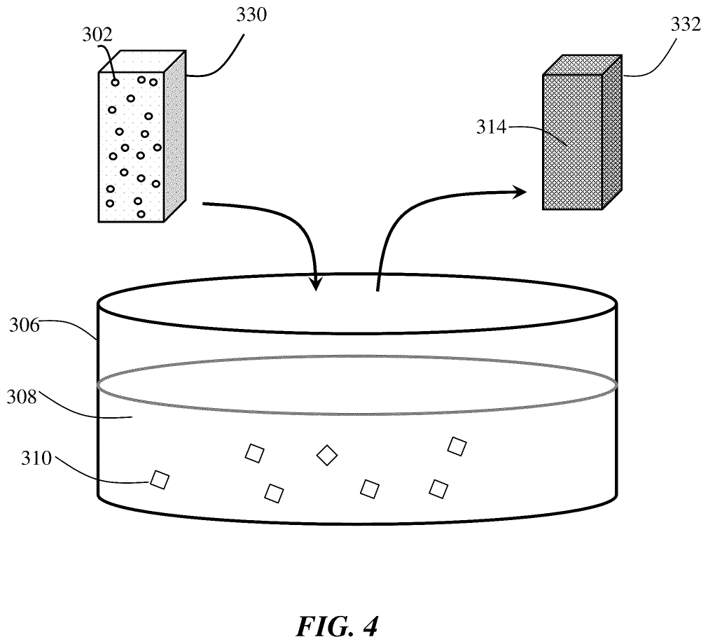

In one set of embodiments, a fully-formed electrode is treated with the poly(phosphate sulfate). FIG. 4 illustrates an example of one such set of embodiments. As shown in FIG. 4, an untreated electrode 330 is exposed to a poly(phosphate sulfate) 310 by submerging untreated electrode 330 in a liquid carrier 308 (which contains poly(phosphate sulfate) 310). Accessible impurities 302 associated with the electrode (e.g., which may comprise an intercalation compound) may react with poly(phosphate sulfate) 310, or may simply be infiltrated with poly(phosphate sulfate) 310 to form treated electrode 332 comprising treated material 314. The treated electrode may undergo further reaction to eliminate accessible impurities 302 after removal from liquid carrier 308. In some embodiments, the treated electrode may be dried and subsequently used as an electrode (e.g., cathode) in an electrochemical cell.

Treatment of the electrode may be accelerated, in some instances, by heating the electrode that is in contact with the poly(phosphate sulfate) compound. Heating may accelerate the treatment reaction, relative to treatment at room temperature, thereby removing a greater proportion of the impurities within the electrode prior to the electrode's use in a final electrochemical cell. An electrode or electrochemical cell described herein may be heated to any of a variety of suitable temperatures, for a period of time during which reaction of electrode impurities is allowed to progress. In some embodiments, an electrode (e.g., electrode material to be treated) or electrochemical cell is heated to a temperature of greater than or equal to 50° C., greater than or equal to 55° C., greater than or equal to 60° C., greater than or equal to 65° C., greater than or equal to 70° C., greater than or equal to 75° C., greater than or equal to 80° C., greater than or equal to 85° C., greater than or equal to 90° C., greater than or equal to 95° C., greater than or equal to 100° C., greater than or equal to 105° C., greater than or equal to 110° C., greater than or equal to 115° C., greater than or equal to 120° C., greater than or equal to 125° C., or greater than or equal to 130° C. In some embodiments, an electrode (e.g., electrode material to be treated) or electrochemical cell is heated to a temperature of less than or equal to 135° C., less than or equal to 130° C., less than or equal to 125° C., less than or equal to 120° C., less than or equal to 115° C., less than or equal to 110° C., less than or equal to 105° C., less than or equal to 100° C., less than or equal to 95° C., less than or equal to 90° C., less than or equal to 85° C., less than or equal to 80° C., less than or equal to 75° C., or less than or equal to 70° C. Combinations of these ranges are also possible (e.g., greater than or equal to 50° C. and less than or equal to 130° C., greater than or equal to 55° C. and less than or equal to 125° C., or greater than or equal to 60° C. and less than or equal to 120° C.) Other ranges are also possible.

An electrode may be heated for any of a variety of appropriate times. In some embodiments, an electrode (e.g., electrode material to be treated) is heated for a time period of greater than or equal to 2 hours, greater than or equal to 4 hours, greater than or equal to 6 hours, greater than or equal to 8 hours, greater than or equal to 10 hours, greater than or equal to 12 hours, greater than or equal to 14 hours, greater than or equal to 16 hours, greater than or equal to 18 hours, greater than or equal to 20 hours, greater than or equal to 24 hours, greater than or equal to 28 hours, greater than or equal to 32 hours, greater than or equal to 36 hours, greater than or equal to 40 hours, greater than or equal to 44 hours, greater than or equal to 48 hours, greater than or equal to 52 hours, greater than or equal to 56 hours, greater than or equal to 60 hours, greater than or equal to 64 hours, greater than or equal to 68 hours, or greater than or equal to 72 hours. In some embodiments, an electrode (e.g., electrode material to be treated) is heated for a time period of less than or equal to 102 hours, less than or equal to 98 hours, less than or equal to 94 hours, less than or equal to 90 hours, less than or equal to 88 hours, less than or equal to 84 hours, less than or equal to 80 hours, less than or equal to 76 hours, less than or equal to 72 hours, less than or equal to 68 hours, less than or equal to 64 hours, less than or equal to 60 hours, less than or equal to 56 hours, less than or equal to 52 hours, less than or equal to 48 hours, less than or equal to 44 hours, less than or equal to 40 hours, less than or equal to 36 hours, less than or equal to 32 hours, less than or equal to 28 hours, less than or equal to 24 hours, less than or equal to 20 hours, less than or equal to 18 hours, less than or equal to 16 hours, less than or equal to 14 hours, less than or equal to 12 hours, less than or equal to 10 hours, less than or equal to 8 hours, less than or equal to 6 hours, or less than or equal to 4 hours. Combinations of these ranges are also possible (e.g., greater than or equal to 2 hours and less than or equal to 102 hours, greater than or equal to 14 hours and less than or equal to 90 hours, or greater than or equal to 60 hours and less than or equal to 72 hours). Other ranges are also possible.

The use of a compound as described above (e.g., a poly(phosphate sulfate)) has been recognized to reduce the generation of gaseous byproducts within electrochemical cells, according to some embodiments. For example, in some embodiments, upon charge/discharge cycling of an electrochemical cell, a treated electrode may advantageously generate a smaller amount of gas (e.g., O₂, CO₂) compared to an otherwise similar but untreated electrode under identical conditions. In some embodiments, a lower amount of gas generation is associated with a reduction in an amount of impurities associated with a treated electrode compared to an amount of impurities associated with an otherwise similar but untreated electrode.

The amount (e.g., a volume) of gaseous products produced in electrochemical cells can be determined using a fluid displacement method, wherein the volume of water displaced by an electrochemical cell or battery prior to cycling is compared with the volume of water displaced by the electrochemical cell or battery after cycling, and the volume difference is assumed to be equal to the volume of gas generated during cycling. One advantage to this method is that the volume of an electrochemical cell (e.g., before cycling, after cycling) can be determined without opening the electrochemical cell (e.g., an assembled electrochemical cell, a sealed electrochemical cell) and may be used to determine the volume of the electrochemical cell and the volume of gaseous products produced.

Alternatively or additionally, in some embodiments, a lower amount of gas generation may be associated with the presence of a poly(phosphate sulfate) within the treated electrode. That is, the presence of poly(phosphate sulfate) may advantageously decrease the surface reactivity and instability of the electrode, thereby reducing the amount of gas generated when the electrode is subjected to high voltage and high temperature conditions (e.g., during charge/discharge cycling). For example, the presence of poly(phosphate sulfate) at an external active surface of an electrode may function as a passivating species and/or a protective layer that reduces the reactivity of the external active surface and prevents undesirable reactions between the electrode and the electrolyte from occurring. Accordingly, in some such embodiments, a lower amount of gas generation may result in a slower degradation of the electrode and an increase in cycle life of an electrochemical cell comprising the electrode.

In one set of embodiments, charge/discharge cycling of an electrode comprising or contacting a poly(phosphate sulfate) may result in a substantially lower amount of gas generation, when compared to an electrochemical cell that contains an untreated electrode that is otherwise identical. For example, in some embodiments, an electrochemical cell comprises a treated electrode that, when cycled at least 5 times (e.g., any 5 cycles between the 5^{th} cycle and the 500^{th} cycle) at a full depth of charge and discharge, can generate gas in an amount that is less than or equal to 99%, less than or equal to 95%, less than or equal to 90%, less than or equal to 85%, less than or equal to 80%, less than or equal to 75%, less than or equal to 70%, less than or equal to 65%, less than or equal to 60%, less than or equal to 55%, less than or equal to 50%, less than or equal to 45%, less than or equal to 40%, less than or equal to 35%, less than or equal to 30%, less than or equal to 25%, less than or equal to 20%, or less than or equal to 15% of the volume of gas that would be generated by an otherwise similar electrochemical cell that contains an untreated electrode. In some embodiments, an electrochemical cell comprises a treated electrode that, when cycled at least 5 times (e.g., any 5 cycles between the 5^{th} cycle and the 500^{th} cycle) at a full depth of charge and discharge, can generate gas in an amount that is greater than or equal to 5%, greater than or equal to 10%, greater than or equal to 15%, greater than or equal to 20%, greater than or equal to 25%, greater than or equal to 30%, greater than or equal to 35%, greater than or equal to 40%, greater than or equal to 45%, greater than or equal to 50%, greater than or equal to 55%, greater than or equal to 60%, greater than or equal to 65%, greater than or equal to 70%, greater than or equal to 75%, greater than or equal to 80%, or greater than or equal to 85% of the volume of gas that would be generated by an otherwise similar electrochemical cell that contains an untreated electrode. Combinations of these ranges are also possible (e.g., greater than or equal to 5% and less than or equal to 99%, greater than or equal to 10% and less than or equal to 95%, or greater than or equal to 15% and less than or equal to 90%). Other ranges are also possible.

The electrochemical cells described herein may comprise an electrolyte. The electrolyte can function as a medium for the storage and transport of ions, and in the special case of solid electrolytes and gel electrolytes, these materials may additionally function as a separator between an anode and a cathode. Any liquid, solid, or gel material capable of storing and transporting ions may be used, so long as the material facilitates the transport of ions (e.g., lithium ions) between the anode and the cathode. The electrolyte is electronically non-conductive to prevent short circuiting between an anode and a cathode. In some embodiments, the electrolyte may comprise a non-solid electrolyte.

In some embodiments, the electrolyte comprises a fluid electrolyte (e.g., a liquid) that can be added at any suitable point in the fabrication process. In some cases, the electrochemical cell is fabricated by providing a first electrode and optionally a second electrode (e.g., an anode and a cathode), applying an anisotropic force component normal to the active surface of the first electrode and/or second electrode, and subsequently adding the fluid electrolyte such that the electrolyte is in electrochemical communication with the first electrode and the optional second electrode, if present. In other cases, the fluid electrolyte is added to the electrochemical cell prior to or simultaneously with the application of an anisotropic force component, after which the electrolyte is in electrochemical communication with the first electrode and the optional second electrode, if present. In some embodiments, the fluid electrolyte is added to the electrochemical cell without the application of anisotropic force, and no anisotropic force is subsequently applied.

An electrolyte may comprise one or more solvents, according to some embodiments. For example, an electrolyte may comprise a non-aqueous solvent. Non-limiting examples of non-aqueous electrolyte solvents include, but are not limited to, non-aqueous organic solvents, such as, for example, carbonates (described in more detail below), an organic amide (e.g., N-methyl acetamide), acetonitrile, acetals (e.g., cyclic or non-cyclic acetals), ketals, esters, sulfones, sulfites, sulfonamides (e.g., asymmetric sulfonamides), sulfolanes, aliphatic ethers, cyclic ethers, acid esters (e.g., organic or inorganic acid esters), glymes, polyethers, phosphate esters, siloxanes, dioxolanes (e.g., 1,3-dioxolane), N-alkylpyrrolidones, bis(trifluoromethanesulfonyl)imide, substituted forms of the foregoing, or blends thereof. Fluorinated derivatives of the foregoing are also useful as liquid electrolyte solvents. In some embodiments, the electrolyte comprises an aqueous solvent, and the disclosure is not so limited.

In some embodiments, the solvent comprises a carbonate (e.g., an organic carbonate). In some embodiments, a carbonate is a linear carbonate. A linear carbonate, according to some embodiments, has the chemical structure (II)

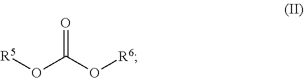

wherein R₅ and R₆ can be the same or different, and each is independently selected from unsubstituted, branched or unbranched aliphatic; substituted or unsubstituted, branched or unbranched haloaliphatic; or substituted or unsubstituted, branched or unbranched haloheteroaliphatic chains comprising between 1 and 10 carbon atoms (e.g., greater than or equal to 2, greater than or equal to 4, greater than or equal to 6, greater than or equal to 8 and/or less than or equal to 10, less than or equal to 8, less than or equal to 6, less than or equal to 4). For example, in some cases, R₅ comprises 1, 2, 3, 4, 5, 6, 7, 8, 9, or 10 carbon atoms. In some cases, R₆ comprises 1, 2, 3, 4, 5, 6, 7, 8, 9, or 10 carbon atoms. For example, the carbonate may be dimethyl carbonate (DMC), diethyl carbonate, or ethylmethyl carbonate (EMC).

In some embodiments, a carbonate is a cyclic carbonate. A cyclic carbonate, according to some embodiments, has the chemical structure (III)

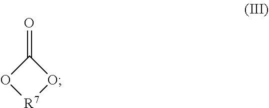

wherein R₇ connects two oxygen atoms to form a heterocycle, and is selected from unsubstituted, unbranched aliphatic; substituted or unsubstituted, unbranched haloaliphatic; or substituted or unsubstituted, unbranched haloheteroaliphatic chains comprising between 1 and 10 carbon atoms (e.g., greater than or equal to 2, greater than or equal to 4, greater than or equal to 6, greater than or equal to 8 and/or less than or equal to 10, less than or equal to 8, less than or equal to 6, less than or equal to 4). For example, in some cases, R₇ comprises 1, 2, 3, 4, 5, 6, 7, 8, 9, or 10 carbon atoms. For example, the cyclic carbonate may be fluoroethylene carbonate (FEC). According to some embodiments, an electrolyte comprises a combination of linear carbonates and cyclic carbonates. For example, in some such cases, the electrolyte may comprise DMC and FEC. In some cases, the electrolyte comprises EMC and FEC. Other combinations of linear and cyclic carbonates, as well as other solvents mentioned elsewhere herein (e.g., carbonates and sulfonamides), are contemplated with the use of electrochemical cells described herein.

According to some embodiments, the electrolyte comprises a salt (e.g., a lithium salt). Examples of ionic electrolyte salts for use in the electrolyte of the electrochemical cells described herein include, but are not limited to, LiSCN, LiBr, LiI, lithium perchlorate (LiClO₄), lithium hexafluoroarsenate (LiAsF₆), LiSO₃CF₃, LiSO₃CH₃, lithium tetrafluoroborate (LiBF₄), LiB(Ph)₄, lithium hexafluorophosphate (LiPF₆), lithium trifluoromethanesulfonate (LiCF₃SO₃), LiC(SO₂CF₃)₃, lithium bis(trifluoromethanesulfonyl)imide (LiN(SO₂CF₃)₂), LiC(CₙF₂ₙ₊₁SO₂)₃, wherein n is an integer in the range of from 1 to 20, LiN(SO₂F)₂, LiAlF₄, LiNO₃, Li₂SiF₆, LiSbF₆, LiAlCl₄, LiBF₂(C₂O₄), lithium bis-oxalatoborate (LiBOB), lithium bis(fluorosulfonyl)imide (LiFSI) and/or salts of the general formula (CₙF₂ₙ₊₁SO₂)ₘXLi with n being an integer in the range of from 1 to 20, m being 1 when X is selected from oxygen or sulfur, m being 2 when X is selected from nitrogen or phosphorus, and m being 3 when X is selected from carbon or silicium. Other electrolyte salts that may be useful include lithium polysulfides (Li₂Sₓ), and lithium salts of organic polysulfides (LiSₓR)ₙ, where x is an integer from 1 to 20, n is an integer from 1 to 3, and R is an organic group, and those disclosed in U.S. Pat. No. 5,538,812 to Lee et al., which is incorporated herein by reference in its entirety for all purposes.

In some embodiments, the electrolyte comprises one or more room temperature ionic liquids. The room temperature ionic liquid, if present, typically comprises one or more cations and one or more anions. Non-limiting examples of suitable cations include lithium cations and/or one or more quaternary ammonium cations such as imidazolium, pyrrolidinium, pyridinium, tetraalkylammonium, pyrazolium, piperidinium, pyridazinium, pyrimidinium, pyrazinium, oxazolium, and trizolium cations. Non-limiting examples of suitable anions include trifluoromethylsulfonate (CF₃SO₃⁻), bis (fluorosulfonyl)imide ((FSO₂)₂N⁻), bis (trifluoromethyl sulfonyl)imide ((CF₃SO₂)₂N⁻, bis (perfluorocthylsulfonyl)imide((CF₃CF₂SO₂)₂N⁻ and tris(trifluoromethylsulfonyl)methide ((CF₃SO₂)₃C⁻. Non-limiting examples of suitable ionic liquids include N-methyl-N-propylpyrrolidinium/bis(fluorosulfonyl) imide and 1,2-dimethyl-3-propylimidazolium/bis(trifluoromethanesulfonyl)imide. In some embodiments, the electrolyte comprises both a room temperature ionic liquid and a lithium salt. In some other embodiments, the electrolyte comprises a room temperature ionic liquid and does not include a lithium salt.

According to some embodiments, the salt forms a portion of the electrolyte. In some embodiments, the salt forms greater than or equal to 2 wt %, greater than or equal to 5 wt %, greater than or equal to 10 wt %, greater than or equal to 15 wt %, greater than or equal to 20 wt %, greater than or equal to 30 wt %, greater than or equal to 40 wt %, or more of the electrolyte. In some embodiments, the salt forms less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 15 wt %, less than or equal to 10 wt %, less than or equal to 5 wt %, or less of the electrolyte. Combinations of these ranges are possible. For example, according to some embodiments, the salt forms greater than or equal to 80 wt % and less than or equal to 5 wt % of the electrolyte. Other ranges are also possible.

The electrolyte can comprise one or more ionic electrolyte salts to provide ionic conductivity and one or more liquid electrolyte solvents, gel polymer materials, or polymer materials. Suitable non-aqueous electrolytes may include organic electrolytes comprising one or more materials selected from the group consisting of liquid electrolytes, gel polymer electrolytes, and solid polymer electrolytes. Examples of non-aqueous electrolytes for lithium batteries are described by Dorniney in Lithium Batteries, New Materials, Developments and Perspectives, Chapter 4, pp. 137-165, Elsevier, Amsterdam (1994). Examples of gel polymer electrolytes and solid polymer electrolytes are described by Alamgir et al. in Lithium Batteries, New Materials, Developments and Perspectives, Chapter 3, pp. 93-136, Elsevier, Amsterdam (1994). Liquid electrolyte compositions that can be used in batteries described herein are described in U.S. patent application Ser. No. 12/312,764, filed May 26, 2009 and entitled “Separation of Electrolytes,” by Mikhaylik et al., which is incorporated herein by reference in its entirety.

A variety of electrodes can be used in the embodiments described herein. In some embodiments, an electrode comprises an intercalation compound (e.g., a lithium intercalation compound). An electrode may, for example, comprise a nickel-containing intercalation compound. In some embodiments, the electroactive material of an electrode (e.g., a cathode) comprises a nickel-containing intercalation compound as well as one or more additional cathode active materials. Examples of additional cathode active materials include, but are not limited to, one or more metal oxides, electroactive transition metal chalcogenides, electroactive conductive polymers, sulfur, carbon and/or combinations thereof.

An electrode may be a cathode, and may comprise a cathode active material. In some embodiments, the cathode active material comprises one or more metal oxides. In some embodiments, an intercalation electrode (e.g., a lithium-intercalation electrode, a lithium-intercalation electrode) may be used. Non-limiting examples of suitable materials that may intercalate ions of an electroactive material (e.g., alkaline metal ions) include metal oxides, titanium sulfide, and iron sulfide. In some embodiments, an electrode (e.g., a cathode) is an intercalation electrode comprising a lithium transition metal oxide or a lithium transition metal phosphate. Examples of cathode active materials include LiₓCoO₂ (e.g., Li_{1.1}CoO₂), LiₓNiO₂, LiₓMnO₂, LiₓMn₂O₄ (e.g., Li_{1.05}Mn₂O₄), LiₓCoPO₄, LiₓMnPO₄. x may be greater than or equal to 0 and less than or equal to 2. x is typically greater than or equal to 1 and less than or equal to 2 when the electrochemical cell is fully discharged, and less than 1 when the electrochemical cell is fully charged. In some embodiments, a fully charged electrochemical cell may have a value of x that is greater than or equal to 1 and less than or equal to 1.05, greater than or equal to 1 and less than or equal to 1.1, or greater than or equal to 1 and less than or equal to 1.2. Further examples include LiCoₓNi₍₁₋ₓ₎O₂ where x is less than or equal to 1, and LiCoₓNi_{y}Mn_{(1-x-y)}O₂ where x and y are less than or equal to 1 and (e.g., LiNi_{1/3}Mn_{1/3}Co_{1/3}O₂, LiNi_{3/5}Mn_{1/5}Co_{1/5}O₂, LiNi_{4/5}Mn_{1/10}Co_{1/10}O₂, LiNi_{1/2}Mn_{3/10}Co_{1/5}O₂). For example, x (and y) may each independently be between 0.05 and 0.8. Further examples include LiₓNiPO₄, where (0<x≤1), LiMnₓNi_{y}O₄ where (x+y=2) (e.g., LiMn_{1.5}Ni_{0.5}O₄), LiNiₓCo_{y}Al_{z}O₂ where (x+y+z=1), LiFePO₄, and combinations thereof. In some embodiments, the electroactive material within an electrode (e.g., a cathode) comprises lithium transition metal phosphates (e.g., LiFePO₄), which can, in some embodiments, be substituted with borates and/or silicates.

In some embodiments, the cathode active material comprises one or more chalcogenides. As used herein, the term “chalcogenides” pertains to compounds that contain one or more of the elements of oxygen, sulfur, and selenium. Examples of suitable transition metal chalcogenides include, but are not limited to, the electroactive oxides, sulfides, and selenides of transition metals selected from the group consisting of Mn, V, Cr, Ti, Fe, Co, Ni, Cu, Y, Zr, Nb, Mo, Ru, Rh, Pd, Ag, Hf, Ta, W, Re, Os, and Ir. In one embodiment, the transition metal chalcogenide is selected from the group consisting of the electroactive oxides of nickel, manganese, cobalt, and vanadium, and the electroactive sulfides of iron. In one embodiment, a cathode includes one or more of the following materials: manganese dioxide, iodine, silver chromate, silver oxide and vanadium pentoxide, copper oxide, copper oxyphosphate, lead sulfide, copper sulfide, iron sulfide, lead bismuthate, bismuth trioxide, cobalt dioxide, copper chloride, manganese dioxide, and carbon. In another embodiment, the cathode active layer comprises an electroactive conductive polymer. Examples of suitable electroactive conductive polymers include, but are not limited to, electroactive and electronically conductive polymers selected from the group consisting of polypyrroles, polyanilines, polyphenylenes, polythiophenes, and polyacetylenes. Examples of conductive polymers include polypyrroles, polyanilines, and polyacetylenes.

An electrode (e.g., a cathode) of the present invention may comprise from about 20 to 100% by weight of electroactive electrode materials (e.g., as measured after an appropriate amount of solvent has been removed from the electrode active layer and/or after the layer has been appropriately cured). In one embodiment, the amount of electroactive material is in the range of 5-30% by weight of the electrode. In another embodiment, the amount of electroactive material in the electrode is in the range of 20% to 90% by weight of the electrode. In some embodiments, the electroactive material described herein, prior to treatment, may be modified (e.g., via vapor deposition or slurry method) with one or more of a metal or a metal-containing compounds. Non-limiting examples of such metal-containing compound include, but are not limited to, Al₂O₃, ZrO₂, SiO₂, AlF₃, TiO₂, LiAlO₂, and various metals (e.g., Al).

In some embodiments, an electrode is an anode, and may comprise an anode-active material. For example, an electrode (e.g., an anode) may comprise a lithium-containing material, wherein lithium is the electroactive material. Suitable electroactive materials (e.g., for use as anode active materials in electrodes) include, but are not limited to, lithium metal such as lithium foil and lithium deposited onto a conductive substrate, and lithium alloys (e.g., lithium-aluminum alloys and lithium-tin alloys). Methods for depositing an anode-active material (e.g., an alkali metal such as lithium) onto a substrate may include methods such as thermal evaporation, sputtering, jet vapor deposition, and laser ablation. Alternatively, where an electrode comprises a lithium foil, or a lithium foil an electrode can be laminated together by a lamination process as known in the art. In some embodiments (e.g., when the electrochemical cell is a lithium-ion cell), an anode is an electrode from which lithium ions are liberated during discharge and into which the lithium ions are integrated (e.g., intercalated) during charge. In some embodiments, an electrode that is an anode comprises an anode active material is a lithium intercalation compound (e.g., a compound that is capable of reversibly inserting lithium ions at lattice sites and/or interstitial sites). In some embodiments, the anode active material comprises carbon. In some cases, the anode active material is or comprises a graphitic material (e.g., graphite). A graphitic material generally refers to a material that comprises a plurality of layers of graphene (i.e., layers comprising carbon atoms covalently bonded in a hexagonal lattice). Adjacent graphene layers are typically attracted to each other via van der Waals forces, although covalent bonds may be present between one or more sheets in some cases. In some cases, the carbon-comprising anode active material is or comprises coke (e.g., petroleum coke). In some embodiments, the anode active material comprises silicon, lithium, and/or any alloys of combinations thereof. In some embodiments, the anode active material comprises lithium titanate (Li₄Ti₅O₁₂, also referred to as “LTO”), tin-cobalt oxide, or any combinations thereof.

In one embodiment, an electroactive lithium-containing material of an electrode (e.g., anode) comprises greater than 50% by weight of lithium. In another embodiment, the electroactive lithium-containing material of an electrode comprises greater than 75% by weight of lithium. In yet another embodiment, the electroactive lithium-containing material of an electrode comprises greater than 90% by weight of lithium. Additional materials and arrangements suitable for use in an electrode are described, for example, in U.S. Patent Publication No. 2010/0035128 to Scordilis-Kelley et al. filed on Aug. 4, 2009, entitled “Application of Force in Electrochemical Cells,” which is incorporated herein by reference in its entirety for all purposes.

In some cases, the lithium metal/lithium metal alloy may be present during only a portion of charge/discharge cycles. For example, the cell can be constructed without any lithium metal/lithium metal alloy on a current collector (e.g., a second current collector), and the lithium metal/lithium metal alloy may subsequently be deposited on the second current collector during a charging step. In some embodiments, lithium may be completely depleted after discharging such that lithium is present during only a portion of the charge/discharge cycle.

An electrochemical cell may comprise an appropriate number of electrodes. In some embodiments, for example, an electrochemical cell comprises a first electrode that is a cathode, and a second electrode that is an anode. In some embodiments, the electrochemical cell does not contain a second electrode. For example, an electrochemical cell may be configured such that a second electrode is not formed until the electrochemical cell is initially charged, according to some embodiments. Thus, the electrochemical cell may comprise one or more electrodes. According to some embodiments, it has been recognized that a first electrode that is a cathode may comprise gas-forming impurities as discussed above. However, the disclosure is not so limited, as an anode may also comprise gas-containing impurities, and one or both electrodes may benefit from contact with a poly(phosphate sulfate) as described above.

In some embodiments, the electrode comprises an electroactive region that includes an external active surface. The term “electroactive region,” as used herein, refers to a region of the electrode within which electrochemical reactions occur during charge and discharge of the electrochemical cell. In some embodiments (e.g., in some embodiments in which the intercalation material is the only electroactive material distributed within a given electrode), the electroactive region corresponds to the region of the electrode within which the electroactive material is distributed. The term “external active surface,” as used herein, refers to the external surface of the electroactive region that is configured to face a counter electrode during cycling of the electrochemical cell. In some embodiments, the external active surface of an electroactive region of a given electrode is the external surface of the electroactive region that is opposite the current collector of that electrode. Generally, the external active surface is a geometric surface (i.e., the surface defining the outer boundaries of the electroactive region, which does not include internal surfaces, such as surface defined by pores within a porous object).

FIG. 1A illustrates an example of such an embodiment. As shown, first electrode 42 (e.g., a cathode) comprises electroactive region 48 that corresponds to the entire region within which the electroactive material has been distributed. Electroactive region 48 can comprise treated electroactive material comprising a sulfur-containing compound (e.g., lithium sulfur oxide), and external active surface 50 that is opposite current collector 52 and is configured to face second electrode 44 (the counter electrode of electrode 42). As mentioned above, second electrode 44 is optional in the electrochemical cell, since the electrochemical cell may be designed such that a second electrode is formed during initial charging of the electrochemical cell. Even in the absence of electrode 44, surface 50 would be considered an electroactive surface, since it would nonetheless be configured to face the counter electrode when the counter electrode ultimately formed during charging.

In some embodiments, an electrochemical cell includes a separator. The separator generally comprises a polymeric material (e.g., polymeric material that does or does not swell upon exposure to electrolyte). In some embodiments, the separator is located between the first electrode and the second electrode (e.g., the anode and the cathode).

The pores of the separator may be partially or substantially filled with liquid electrolyte. Separators may be supplied as porous free-standing films which are interleaved with the first electrode and/or the second electrode (e.g., the anode and the cathode) during the fabrication of cells. Alternatively, the porous separator layer may be applied directly to the surface of one of the electrodes, for example, as described in PCT Publication No. WO 99/33125 to Carlson et al. and in U.S. Pat. No. 5,194,341 to Bagley et al.

A variety of separator materials are known in the art. Examples of suitable solid porous separator materials include, but are not limited to, polyolefins, such as, for example, polyethylenes (e.g., SETELA™ made by Tonen Chemical Corp) and polypropylenes, glass fiber filter papers, and ceramic materials. For example, in some embodiments, the separator comprises a microporous polyethylene film. Further examples of separators and separator materials suitable for use in the electrochemical cells described herein are those comprising a microporous xerogel layer, for example, a microporous pseudo-boehmite layer, which may be provided either as a free standing film or by a direct coating application on one of the electrodes (e.g., the second electrode), as described in U.S. Pat. Nos. 6,153,337 and 6,306,545 by Carlson et al. Solid electrolytes and gel electrolytes may also function as a separator in addition to their electrolyte function.

The separator generally comprises a polymeric material (e.g., polymeric material that does or does not swell upon exposure to electrolyte). In some embodiments, the separator is located between the electrolyte and an electrode (e.g., between the electrolyte and a first electrode, between the electrolyte and a second electrode, between the electrolyte and the first electrode, or between the electrolyte and the second electrode).

A separator can be made of a variety of materials. The separator may be polymeric in some instances, or formed of an inorganic material (e.g., glass fiber filter papers) in other instances. Examples of suitable separator materials include, but are not limited to, polyolefins (e.g., polyethylenes, poly(butene-1), poly(n-pentene-2), polypropylene, polytetrafluoroethylene), polyamines (e.g., poly(ethylene imine) and polypropylene imine (PPI)); polyamides (e.g., polyamide (Nylon), poly(ϵ-caprolactam) (Nylon 6), poly(hexamethylene adipamide) (Nylon 66)), polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly(vinyl alcohol), poly(vinyl chloride), poly(vinyl fluoride), poly(2-vinyl pyridine), vinyl polymer, polychlorotrifluoro ethylene, and poly(isohexylcynaoacrylate)); polyacetals; polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some embodiments, the polymer may be selected from poly(n-pentene-2), polypropylene, polytetrafluoroethylene, polyamides (e.g., polyamide (Nylon), poly(ϵ-caprolactam) (Nylon 6), poly(hexamethylene adipamide) (Nylon 66)), polyimides (e.g., polynitrile, and poly(pyromellitimide-1,4-diphenyl ether) (Kapton®) (NOMEX®) (KEVLAR®)), polyether ether ketone (PEEK), and combinations thereof.

In some embodiments, an electrochemical cell comprises a protective layer over the electroactive material of the electrode (e.g., a first electrode, a second electrode). Generally, a “protective layer” is a layer of material that protects the electrode active material within the electrode from non-electrochemical chemical reactions or other unfavorable interaction with species within the electrochemical cell. An electrode of the electrochemical cell may comprise one or more coatings or layers formed from polymers, ceramics, and/or glasses. The coating may serve as a protective layer and may serve different functions. For example, the protective layer can be configured to prevent chemical reaction or other unfavorable interaction between the electrode active material and a species within the electrolyte and/or between the electrode active material and a side product of the electrochemical reaction within the electrochemical cell. Functions of the protective layer may include preventing the formation of dendrites during recharging which could otherwise cause short circuiting, preventing reaction of the electrode active material with electrolyte, and improving cycle life. Examples of such protective layers include those described in: U.S. Pat. No. 8,338,034 to Affinito et al. and U.S. Patent Publication No. 2015/0236322 to Laramie at al., each of which is incorporated herein by reference in its entirety for all purposes.

According to some embodiments, the protective layer is over the electroactive material of an anode. For example, the protective layer is disposed between the anode and the separator, according to some embodiments.

The electrochemical cells described herein may comprise one or more current collectors, as mentioned above. In some cases, the electrochemical cells comprise an anodic current collector (e.g., second current collector 54 in FIG. 1A). The anodic current collector may be electronically coupled to an anode and/or a plurality of anode portions of the electrochemical device.

In some embodiments, the electrochemical cells described herein comprise a cathodic current collector (e.g., first current collector 52 in FIG. 1A). The cathodic current collector may be electronically coupled to a cathode and/or a plurality of cathode portions of the electrochemical cell.

In some embodiments, it can be advantageous to apply an anisotropic force to the electrochemical cells described herein during charge and/or discharge. In some embodiments, the electrochemical cells and/or the electrodes described herein can be configured to withstand an applied anisotropic force (e.g., a force applied to enhance the morphology of an electrode within the cell) while maintaining their structural integrity. The electrodes described herein may be a part of an electrochemical cell that is adapted and arranged such that, during at least one period of time during charge and/or discharge of the cell, an anisotropic force with a component normal to the active surface of an electrode within the electrochemical cell (e.g., an anode comprising lithium metal and/or a lithium alloy) is applied to the cell. In one set of embodiments, the applied anisotropic force can be selected to enhance the morphology of an electrode (e.g., an anode such as a lithium metal and/or a lithium alloy anode). As understood in the art, an “anisotropic force” is a force that is not equal in all directions.

In some such cases, the anisotropic force comprises a component normal to an active surface of an electrode (e.g., a first electrode such as a cathode, a second electrode such as an anode) within an electrochemical cell. As used herein, the term “active surface” is used to describe a surface of an electrode at which electrochemical reactions may take place. A force with a “component normal” to a surface is given its ordinary meaning as would be understood by those of ordinary skill in the art and includes, for example, a force which at least in part exerts itself in a direction substantially perpendicular to the surface. For example, in the case of a horizontal table with an object resting on the table and affected only by gravity, the object exerts a force essentially completely normal to the surface of the table. If the object is also urged laterally across the horizontal table surface, then it exerts a force on the table which, while not completely perpendicular to the horizontal surface, includes a component normal to the table surface. Those of ordinary skill will understand other examples of these terms, especially as applied within the description of this document. In the case of a curved surface (for example, a concave surface or a convex surface), the component of the anisotropic force that is normal to an active surface of an electrode may correspond to the component normal to a plane that is tangent to the curved surface at the point at which the anisotropic force is applied. The anisotropic force may be applied, in some cases, at one or more pre-determined locations, optionally distributed over the active surface of the anode. In some embodiments, the anisotropic force is applied uniformly over the active surface of the first electrode (e.g., a cathode) and/or the second electrode (e.g., an anode).

Referring back to FIG. 1A, which illustrates an exemplary electrochemical cell as described herein, a force may be applied in the direction of arrow 58. Arrow 60 illustrates the component of force 58 that is normal to anode active surface portion 56 of anode 44 as well as cathode active surface 50 of cathode 42.

Any of the electrochemical cell properties and/or performance metrics described herein may be achieved, alone or in combination with each other, while an anisotropic force is applied to the electrochemical cell (e.g., during charge and/or discharge of the cell) during charge and/or discharge. In some embodiments, the anisotropic force applied to the electrode, to the electrochemical cell (e.g., during at least one period of time during charge and/or discharge of the cell) can include a component normal to an active surface of an electrode (e.g., an anode such as a lithium metal and/or lithium alloy anode within the electrochemical cell). In some embodiments, the component of the anisotropic force that is normal to the active surface of the electrode defines a pressure of greater than or equal to 1 kg/cm², greater than or equal to 2 kg/cm², greater than or equal to 4 kg/cm², greater than or equal to 6 kg/cm², greater than or equal to 8 kg/cm², greater than or equal to 10 kg/cm², greater than or equal to 12 kg/cm², greater than or equal to 14 kg/cm², greater than or equal to 16 kg/cm², greater than or equal to 18 kg/cm², greater than or equal to 20 kg/cm², greater than or equal to 22 kg/cm², greater than or equal to 24 kg/cm², greater than or equal to 26 kg/cm², greater than or equal to 28 kg/cm², greater than or equal to 30 kg/cm², greater than or equal to 32 kg/cm², greater than or equal to 34 kg/cm², greater than or equal to 36 kg/cm², greater than or equal to 38 kg/cm², greater than or equal to 40 kg/cm², greater than or equal to 42 kg/cm², greater than or equal to 44 kg/cm², greater than or equal to 46 kg/cm², or greater than or equal to 48 kg/cm². In some embodiments, the component of the anisotropic force normal to the active surface may, for example, define a pressure of less than or equal to 50 kg/cm², less than or equal to 48 kg/cm², less than or equal to 46 kg/cm², less than or equal to 44 kg/cm², less than or equal to 42 kg/cm², less than or equal to 40 kg/cm², less than or equal to 38 kg/cm², less than or equal to 36 kg/cm², less than or equal to 34 kg/cm², less than or equal to 32 kg/cm², less than or equal to 30 kg/cm², less than or equal to 28 kg/cm², less than or equal to 26 kg/cm², less than or equal to 24 kg/cm², less than or equal to 22 kg/cm², less than or equal to 20 kg/cm², less than or equal to 18 kg/cm², less about 16 kg/cm², less than or equal to 14 kg/cm², less than or equal to 12 kg/cm², less than or equal to 10 kg/cm², less than or equal to 8 kg/cm², less than or equal to 6 kg/cm², less than or equal to 4 kg/cm², or less than or equal to 2 kg/cm². Combinations of the above-referenced ranges are also possible (e.g., greater than or equal to 1 kg/cm² and less than or equal to 50 kg/cm²). Other ranges are possible.

The anisotropic forces applied during charge and/or discharge as described herein may be applied using any method known in the art. In some embodiments, the force may be applied using compression springs. Forces may be applied using other elements (either inside or outside a containment structure) including, but not limited to Belleville washers, machine screws, pneumatic devices, and/or weights, among others. In some cases, cells may be pre-compressed before they are inserted into containment structures, and, upon being inserted to the containment structure, they may expand to produce a net force on the cell. Suitable methods for applying such forces are described in detail, for example, in U.S. Pat. No. 9,105,938, which is incorporated herein by reference in its entirety.

In some embodiments, an electrochemical cell described herein is included in a battery. Generally, a battery comprises a first electrochemical cell and a second electrochemical cell—one or both of which may include an electrode that has been treated with a poly(phosphate sulfate). A battery may comprise greater than or equal to 2, greater than or equal to 3, greater than or equal to 4, greater than or equal to 5, greater than or equal to 6, greater than or equal to 7, greater than or equal to 8, greater than or equal to 9, greater than or equal to 10, greater than or equal to 15, greater than or equal to 25, or more electrochemical cells.

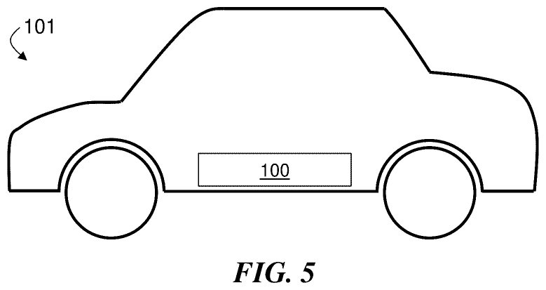

In some embodiments, the electrochemical cells and batteries (e.g., rechargeable batteries) described in this disclosure can be used to provide power to an electric vehicle or otherwise be incorporated into an electric vehicle. As a non-limiting example, an electrochemical cell and/or a battery described in this disclosure (e.g., comprising lithium metal and/or lithium alloy electrochemical cells) can, in some embodiments, be used to provide power to a drive train of an electric vehicle. The vehicle may be any suitable vehicle, adapted for travel on land, sea, and/or air. For example, the vehicle may be an automobile, truck, motorcycle, boat, helicopter, airplane, and/or any other suitable type of vehicle. FIG. 5 shows a cross-sectional schematic diagram of electric vehicle 101 in the form of an automobile comprising battery 100, in accordance with some embodiments. Battery 100 can, in some instances, provide power to a drive train of electric vehicle 101.

The term “aliphatic,” as used herein, includes both saturated and unsaturated, nonaromatic, straight chain (i.e., unbranched), branched, acyclic, and cyclic (i.e., carbocyclic) hydrocarbons, which are optionally substituted with one or more functional groups. As will be appreciated by one of ordinary skill in the art, “aliphatic” is intended herein to include, but is not limited to, alkyl, alkenyl, alkynyl, cycloalkyl, cycloalkenyl, and cycloalkynyl moieties. Likewise, the term “heteroaliphatic” refers to heteroalkyl, heteroalkenyl, heteroalkynyl, and heterocyclic groups. Thus, as used herein, the term “alkyl” includes straight, branched and cyclic alkyl groups. An analogous convention applies to other generic terms such as “alkenyl”, “alkynyl”, and the like. Furthermore, as used herein, the terms “alkyl”, “alkenyl”, “alkynyl”, and the like encompass both substituted and unsubstituted groups. In some embodiments, as used herein, “aliphatic” is used to indicate those aliphatic groups (cyclic, acyclic, substituted, unsubstituted, branched or unbranched) having 1-20 carbon atoms. Aliphatic group substituents include, but are not limited to, any of the substituents described herein, that result in the formation of a stable moiety (e.g., aliphatic, alkyl, alkenyl, alkynyl, heteroaliphatic, heterocyclic, aryl, heteroaryl, acyl, oxo, imino, thiooxo, cyano, isocyano, amino, azido, nitro, hydroxyl, thiol, halo, aliphaticamino, heteroaliphaticamino, alkylamino, heteroalkylamino, arylamino, heteroarylamino, alkylaryl, arylalkyl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, acyloxy, and the like, each of which may or may not be further substituted).

The term “alkyl” refers to the radical of saturated aliphatic groups, including straight-chain alkyl groups, branched-chain alkyl groups, cycloalkyl (alicyclic) groups, alkyl substituted cycloalkyl groups, and cycloalkyl substituted alkyl groups. The alkyl groups may be optionally substituted, as described more fully below. Examples of alkyl groups include, but are not limited to, methyl, ethyl, propyl, isopropyl, butyl, isobutyl, tert-butyl, 2-ethylhexyl, cyclopropyl, cyclobutyl, cyclopentyl, cyclohexyl, and the like.

The term “haloaliphatic” refers to an aliphatic group, wherein one or more hydrogen atoms, such as one to 10 hydrogen atoms, are independently replaced with a halogen atom, such as fluoro, bromo, chloro, or iodo.

The term “haloheteroaliphatic” refers to a heteroaliphatic group, wherein one or more hydrogen atoms, such as one to 10 hydrogen atoms, are independently replaced with a halogen atom, such as fluoro, bromo, chloro, or iodo.

The terms “amine” and “amino” refer to both unsubstituted and substituted amines, e.g., a moiety that can be represented by the general formula: N(R′)(R″)(R′″) wherein R′, R″, and R′″ each independently represent a group permitted by the rules of valence.

The terms “acyl,” “carboxyl group,” or “carbonyl group” are recognized in the art and can include such moieties as can be represented by the general formula:

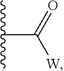

wherein W is H, OH, O-alkyl, O-alkenyl, or a salt thereof. Where W is O-alkyl, the formula represents an “ester.” On the other hand, where W is alkyl, the above formula represents a “ketone” group. Where W is hydrogen, the above formula represents an “aldehyde” group.

As used herein, the term “heteroaromatic” or “heteroaryl” means a monocyclic or polycyclic heteroaromatic ring (or radical thereof) comprising carbon atom ring members and one or more heteroatom ring members (such as, for example, oxygen, sulfur or nitrogen). Typically, the heteroaromatic ring has from 5 to about 14 ring members in which at least 1 ring member is a heteroatom selected from oxygen, sulfur, and nitrogen. In another embodiment, the heteroaromatic ring is a 5 or 6 membered ring and may contain from 1 to about 4 heteroatoms. In another embodiment, the heteroaromatic ring system has a 7 to 14 ring members and may contain from 1 to about 7 heteroatoms. Representative heteroaryls include pyridyl, furyl, thienyl, pyrrolyl, oxazolyl, imidazolyl, indolizinyl, thiazolyl, isoxazolyl, pyrazolyl, isothiazolyl, pyridazinyl, pyrimidinyl, pyrazinyl, triazinyl, triazolyl, pyridinyl, thiadiazolyl, pyrazinyl, quinolyl, isoquinolyl, indazolyl, benzoxazolyl, benzofuryl, benzothiazolyl, indolizinyl, imidazopyridinyl, isothiazolyl, tetrazolyl, benzimidazolyl, benzoxazolyl, benzothiazolyl, benzothiadiazolyl, benzoxadiazolyl, carbazolyl, indolyl, tetrahydroindolyl, azaindolyl, imidazopyridyl, qunizaolinyl, purinyl, pyrrolo[2,3]pyrimidyl, pyrazolo[3,4]pyrimidyl, benzo(b)thienyl, and the like. These heteroaryl groups may be optionally substituted with one or more substituents.

The term “substituted” is contemplated to include all permissible substituents of organic compounds, “permissible” being in the context of the chemical rules of valence known to those of ordinary skill in the art. In some cases, “substituted” may generally refer to replacement of a hydrogen with a substituent as described herein. However, “substituted,” as used herein, does not encompass replacement and/or alteration of a key functional group by which a molecule is identified, e.g., such that the “substituted” functional group becomes, through substitution, a different functional group. For example, a “substituted phenyl” must still comprise the phenyl moiety and cannot be modified by substitution, in this definition, to become, e.g., a heteroaryl group such as pyridine. In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. For purposes of this invention, the heteroatoms such as nitrogen may have hydrogen substituents and/or any permissible substituents of organic compounds described herein which satisfy the valencies of the heteroatoms. This invention is not intended to be limited in any manner by the permissible substituents of organic compounds.

Examples of substituents include, but are not limited to, alkyl, aryl, aralkyl, cyclic alkyl, heterocycloalkyl, hydroxy, alkoxy, aryloxy, perhaloalkoxy, aralkoxy, heteroaryl, heteroaryloxy, heteroarylalkyl, heteroaralkoxy, azido, amino, halogen, alkylthio, oxo, acyl, acylalkyl, carboxy esters, carboxyl, carboxamido, nitro, acyloxy, aminoalkyl, alkylaminoaryl, alkylaryl, alkylaminoalkyl, alkoxyaryl, arylamino, aralkylamino, alkylsulfonyl, carboxamidoalkylaryl, carboxamidoaryl, hydroxyalkyl, haloalkyl, alkylaminoalkylcarboxy, aminocarboxamidoalkyl, alkoxyalkyl, perhaloalkyl, arylalkyloxyalkyl, and the like.

It should be understood that when a portion (e.g., layer, structure, region) is “on”, “adjacent”, “above”, “over”, “overlying”, or “supported by” another portion, it can be directly on the portion, or an intervening portion (e.g., layer, structure, region) also may be present. Similarly, when a portion is “below” or “underneath” another portion, it can be directly below the portion, or an intervening portion (e.g., layer, structure, region) also may be present. A portion that is “directly on”, “directly adjacent”, “immediately adjacent”, “in direct contact with”, or “directly supported by” another portion means that no intervening portion is present. It should also be understood that when a portion is referred to as being “on”, “above”, “adjacent”, “over”, “overlying”, “in contact with”, “below”, or “supported by” another portion, it may cover the entire portion or a part of the portion.

The following applications are incorporated herein by reference, in their entirety, for all purposes: U.S. Publication No. US-2007-0221265-A1 published on Sep. 27, 2007, filed as U.S. application Ser. No. 11/400,781 on Apr. 6, 2006, and entitled “RECHARGEABLE LITHIUM/WATER, LITHIUM/AIR BATTERIES”; U.S. Publication No. US-2009-0035646-A1, published on Feb. 5, 2009, filed as U.S. application Ser. No. 11/888,339 on Jul. 31, 2007, and entitled “SWELLING INHIBITION IN BATTERIES”; U.S. Publication No. US-2010-0129699-A1 published on May 17, 2010, filed as U.S. application Ser. No. 12/312,764 on Feb. 2, 2010; patented as U.S. Pat. No. 8,617,748 on Dec. 31, 2013, and entitled “SEPARATION OF ELECTROLYTES”; U.S. Publication No. US-2010-0291442-A1 published on Nov. 18, 2010, filed as U.S. application Ser. No. 12/682,011 on Jul. 30, 2010, patented as U.S. Pat. No. 8,871,387 on Oct. 28, 2014, and entitled “PRIMER FOR BATTERY ELECTRODE”; U.S. Publication No. US-2009-0200986-A1 published on Aug. 13, 2009, filed as U.S. application Ser. No. 12/069,335 on Feb. 8, 2008, patented as U.S. Pat. No. 8,264,205 on Sep. 11, 2012, and entitled “CIRCUIT FOR CHARGE AND/OR DISCHARGE PROTECTION IN AN ENERGY-STORAGE DEVICE”; U.S. Publication No. US-2007-0224502-A1 published on Sep. 27, 2007, filed as U.S. application Ser. No. 11/400,025 on Apr. 6, 2006, patented as U.S. Pat. No. 7,771,870 on Aug. 10, 2010, and entitled “ELECTRODE PROTECTION IN BOTH AQUEOUS AND NON-AQUEOUS ELECTROCHEMICAL CELLS, INCLUDING RECHARGEABLE LITHIUM BATTERIES”; U.S. Publication No. US-2008-0318128-A1 published on Dec. 25, 2008, filed as U.S. application Ser. No. 11/821,576 on Jun. 22, 2007, and entitled “LITHIUM ALLOY/SULFUR BATTERIES”; U.S. Publication No. US-2002-0055040-A1 published on May 9, 2002, filed as U.S. application Ser. No. 09/795,915 on Feb. 27, 2001, patented as U.S. Pat. No. 7,939,198 on May 10, 2011, and entitled “NOVEL COMPOSITE CATHODES, ELECTROCHEMICAL CELLS COMPRISING NOVEL COMPOSITE CATHODES, AND PROCESSES FOR FABRICATING SAME”; U.S. Publication No. US-2006-0238203-A1 published on Oct. 26, 2006, filed as U.S. application Ser. No. 11/111,262 on Apr. 20, 2005, patented as U.S. Pat. No. 7,688,075 on Mar. 30, 2010, and entitled “LITHIUM SULFUR RECHARGEABLE BATTERY FUEL GAUGE SYSTEMS AND METHODS”; U.S. Publication No. US-2008-0187663-A1 published on Aug. 7, 2008, filed as U.S. application Ser. No. 11/728,197 on Mar. 23, 2007, patented as U.S. Pat. No. 8,084,102 on Dec. 27, 2011, and entitled “METHODS FOR CO-FLASH EVAPORATION OF POLYMERIZABLE MONOMERS AND NON-POLYMERIZABLE CARRIER SOLVENT/SALT MIXTURES/SOLUTIONS”; U.S. Publication No. US-2011-0006738-A1 published on Jan. 13, 2011, filed as U.S. application Ser. No. 12/679,371 on Sep. 23, 2010, and entitled “ELECTROLYTE ADDITIVES FOR LITHIUM BATTERIES AND RELATED METHODS”; U.S. Publication No. US-2011-0008531-A1 published on Jan. 13, 2011, filed as U.S. application Ser. No. 12/811,576 on Sep. 23, 2010, patented as U.S. Pat. No. 9,034,421 on May 19, 2015, and entitled “METHODS OF FORMING ELECTRODES COMPRISING SULFUR AND POROUS MATERIAL COMPRISING CARBON”; U.S. Publication No. US-2010-0035128-A1 published on Feb. 11, 2010, filed as U.S. application Ser. No. 12/535,328 on Aug. 4, 2009, patented as U.S. Pat. No. 9,105,938 on Aug. 11, 2015, and entitled “APPLICATION OF FORCE IN ELECTROCHEMICAL CELLS”; U.S. Publication No. US-2011-0165471-A9 published on Jul. 15, 2011, filed as U.S. application Ser. No. 12/180,379 on Jul. 25, 2008, and entitled “PROTECTION OF ANODES FOR ELECTROCHEMICAL CELLS”; U.S. Publication No. US-2006-0222954-A1 published on Oct. 5, 2006, filed as U.S. application Ser. No. 11/452,445 on Jun. 13, 2006, patented as U.S. Pat. No. 8,415,054 on Apr. 9, 2013, and entitled “LITHIUM ANODES FOR ELECTROCHEMICAL CELLS”; U.S. Publication No. US-2010-0239914-A1 published on Sep. 23, 2010, filed as U.S. application Ser. No. 12/727,862 on Mar. 19, 2010, and entitled “CATHODE FOR LITHIUM BATTERY”; U.S. Publication No. US-2010-0294049-A1 published on Nov. 25, 2010, filed as U.S. application Ser. No. 12/471,095 on May 22, 2009, patented as U.S. Pat. No. 8,087,309 on Jan. 3, 2012, and entitled “HERMETIC SAMPLE HOLDER AND METHOD FOR PERFORMING MICROANALYSIS UNDER CONTROLLED ATMOSPHERE ENVIRONMENT”; U.S. Publication No. US-2011-0076560-A1 published on Mar. 31, 2011, filed as U.S. application Ser. No. 12/862,581 on Aug. 24, 2010, and entitled “ELECTROCHEMICAL CELLS COMPRISING POROUS STRUCTURES COMPRISING SULFUR”; U.S. Publication No. US-2011-0068001-A1 published on Mar. 24, 2011, filed as U.S. application Ser. No. 12/862,513 on Aug. 24, 2010, and entitled “RELEASE SYSTEM FOR ELECTROCHEMICAL CELLS”; U.S. Publication No. US-2012-0048729-A1 published on Mar. 1, 2012, filed as U.S. application Ser. No. 13/216,559 on Aug. 24, 2011, and entitled “ELECTRICALLY NON-CONDUCTIVE MATERIALS FOR ELECTROCHEMICAL CELLS”; U.S. Publication No. US-2011-0177398-A1 published on Jul. 21, 2011, filed as U.S. application Ser. No. 12/862,528 on Aug. 24, 2010, patented as U.S. Pat. No. 10,629,947 on Apr. 21, 2020, and entitled “ELECTROCHEMICAL CELL”; U.S. Publication No. US-2011-0070494-A1 published on Mar. 24, 2011, filed as U.S. application Ser. No. 12/862,563 on Aug. 24, 2010, and entitled “ELECTROCHEMICAL CELLS COMPRISING POROUS STRUCTURES COMPRISING SULFUR”; U.S. Publication No. US-2011-0070491-A1 published on Mar. 24, 2011, filed as U.S. application Ser. No. 12/862,551 on Aug. 24, 2010, and entitled “ELECTROCHEMICAL CELLS COMPRISING POROUS STRUCTURES COMPRISING SULFUR”; U.S. Publication No. US-2011-0059361-A1 published on Mar. 10, 2011, filed as U.S. application Ser. No. 12/862,576 on Aug. 24, 2010, patented as U.S. Pat. No. 9,005,809 on Apr. 14, 2015, and entitled “ELECTROCHEMICAL CELLS COMPRISING POROUS STRUCTURES COMPRISING SULFUR”; U.S. Publication No. US-2012-0052339-A1 published on Mar. 1, 2012, filed as U.S. application Ser. No. 13/216,579 on Aug. 24, 2011, and entitled “ELECTROLYTE MATERIALS FOR USE IN ELECTROCHEMICAL CELLS”; U.S. Publication No. US-2012-0070746-A1 published on Mar. 22, 2012, filed as U.S. application Ser. No. 13/240,113 on Sep. 22, 2011, and entitled “LOW ELECTROLYTE ELECTROCHEMICAL CELLS”; U.S. Publication No. US-2011-0206992-A1 published on Aug. 25, 2011, filed as U.S. application Ser. No. 13/033,419 on Feb. 23, 2011, and entitled “POROUS STRUCTURES FOR ENERGY STORAGE DEVICES”; U.S. Publication No. US-2012-0082872-A1 published on Apr. 5, 2012, filed as U.S. application Ser. No. 13/249,605 on Sep. 30, 2011, and entitled “ADDITIVE FOR ELECTROLYTES”; U.S. Publication No. US-2012-0082901-A1 published on Apr. 5, 2012, filed as U.S. application Ser. No. 13/249,632 on Sep. 30, 2011, and entitled “LITHIUM-BASED ANODE WITH IONIC LIQUID POLYMER GEL”; U.S. Publication No. US-2013-0164635-A1 published on Jun. 27, 2013, filed as U.S. application Ser. No. 13/700,696 on Mar. 6, 2013, patented as U.S. Pat. No. 9,577,243 on Feb. 21 2017, and entitled “USE OF EXPANDED GRAPHITE IN LITHIUM/SULPHUR BATTERIES”; U.S. Publication No. US-2013-0017441-A1 published on Jan. 17, 2013, filed as U.S. application Ser. No. 13/524,662 on Jun. 15, 2012, patented as U.S. Pat. No. 9,548,492 on Jan. 17, 2017, and entitled “PLATING TECHNIQUE FOR ELECTRODE”; U.S. Publication No. US-2013-0224601-A1 published on Aug. 29, 2013, filed as U.S. application Ser. No. 13/766,862 on Feb. 14, 2013, patented as U.S. Pat. No. 9,077,041 on Jul. 7, 2015, and entitled “ELECTRODE STRUCTURE FOR ELECTROCHEMICAL CELL”; U.S. Publication No. US-2013-0252103-A1 published on Sep. 26, 2013, filed as U.S. application Ser. No. 13/789,783 on Mar. 8, 2013, patented as U.S. Pat. No. 9,214,678 on Dec. 15, 2015, and entitled “POROUS SUPPORT STRUCTURES, ELECTRODES CONTAINING SAME, AND ASSOCIATED METHODS”; U.S. Publication No. US-2015-0287998-A1 published on Oct. 8, 2015, filed as U.S. application Ser. No. 14/743,304 on Jun. 18, 2015, patented as U.S. Pat. No. 9,577,267 on Feb. 21, 2017, and entitled “ELECTRODE STRUCTURE AND METHOD FOR MAKING SAME”; U.S. Publication No. US-2013-0095380-A1 published on Apr. 18, 2013, filed as U.S. application Ser. No. 13/644,933 on Oct. 4, 2012, patented as U.S. Pat. No. 8,936,870 on Jan. 20, 2015, and entitled “ELECTRODE STRUCTURE AND METHOD FOR MAKING THE SAME”; U.S. Publication No. US-2012-0052397-A1 published on Mar. 1, 2012, filed as U.S. application Ser. No. 13/216,538 on Aug. 24, 2011, patented as U.S. Pat. No. 9,853,287 on Dec. 26, 2017, and entitled “ELECTROLYTE MATERIALS FOR USE IN ELECTROCHEMICAL CELLS”; U.S. Publication No. US-2014-0123477-A1 published on May 8, 2014, filed as U.S. application Ser. No. 14/069,698 on Nov. 1, 2013, patented as U.S. Pat. No. 9,005,311 on Apr. 14, 2015, and entitled “ELECTRODE ACTIVE SURFACE PRETREATMENT”; U.S. Publication No. US-2014-0193723-A1 published on Jul. 10, 2014, filed as U.S. application Ser. No. 14/150,156 on Jan. 8, 2014, patented as U.S. Pat. No. 9,559,348 on Jan. 31, 2017, and entitled “CONDUCTIVITY CONTROL IN ELECTROCHEMICAL CELLS”; U.S. Publication No. US-2014-0255780-A1 published on Sep. 11, 2014, filed as U.S. application Ser. No. 14/197,782 on Mar. 5, 2014, patented as U.S. Pat. No. 9,490,478 on Nov. 8, 2016, and entitled “ELECTROCHEMICAL CELLS COMPRISING FIBRIL MATERIALS”; U.S. Publication No. US-2014-0272594-A1 published on Sep. 18 2014, filed as U.S. application Ser. No. 13/833,377 on Mar. 15, 2013, and entitled “PROTECTIVE STRUCTURES FOR ELECTRODES”; U.S. Publication No. US-2014-0272597-A1 published on Sep. 18, 2014, filed as U.S. application Ser. No. 14/209,274 on Mar. 13, 2014, patented as U.S. Pat. No. 9,728,768 on Aug. 8, 2017, and entitled “PROTECTED ELECTRODE STRUCTURES AND METHODS”; U.S. Publication No. US-2015-0280277-A1 published on Oct. 1, 2015, filed as U.S. application Ser. No. 14/668,102 on Mar. 25, 2015, patented as U.S. Pat. No. 9,755,268 on Sep. 5, 2017, and entitled “GEL ELECTROLYTES AND ELECTRODES”; U.S. Publication No. US-2015-0180037-A1 published on Jun. 25, 2015, filed as U.S. application Ser. No. 14/576,570 on Dec. 19, 2014, patented as U.S. Pat. No. 10,020,512 on Jul. 10, 2018, and entitled “POLYMER FOR USE AS PROTECTIVE LAYERS AND OTHER COMPONENTS IN ELECTROCHEMICAL CELLS”; U.S. Publication No. US-2015-0349310-A1 published on Dec. 3, 2015, filed as U.S. application Ser. No. 14/723,132 on May 27, 2015, patented as U.S. Pat. No. 9,735,411 on Aug. 15, 2017, and entitled “POLYMER FOR USE AS PROTECTIVE LAYERS AND OTHER COMPONENTS IN ELECTROCHEMICAL CELLS”; U.S. Publication No. US-2014-0272595-A1 published on Sep. 18, 2014, filed as U.S. application Ser. No. 14/203,802 on Mar. 11, 2014, and entitled “COMPOSITIONS FOR USE AS PROTECTIVE LAYERS AND OTHER COMPONENTS IN ELECTROCHEMICAL CELLS”; U.S. Publication No. US-2019-0006699-A1 published on Jan. 3, 2019, filed as U.S. application Ser. No. 15/727,438 on Oct. 6, 2017, and entitled “PRESSURE AND/OR TEMPERATURE MANAGEMENT IN ELECTROCHEMICAL SYSTEMS”; U.S. Publication No. US-2014-0193713-A1 published on Jul. 10, 2014, filed as U.S. application Ser. No. 14/150,196 on Jan. 8, 2014, patented as U.S. Pat. No. 9,531,009 on Dec. 27, 2016, and entitled “PASSIVATION OF ELECTRODES IN ELECTROCHEMICAL CELLS”; U.S. Publication No. US-2014-0127577-A1 published on May 8, 2014, filed as U.S. application Ser. No. 14/068,333 on Oct. 31, 2013, patented as U.S. Pat. No. 10,243,202 on Mar. 26, 2019, and entitled “POLYMERS FOR USE AS PROTECTIVE LAYERS AND OTHER COMPONENTS IN ELECTROCHEMICAL CELLS”; U.S. Publication No. US-2015-0318539-A1 published on Nov. 5, 2015, filed as U.S. application Ser. No. 14/700,258 on Apr. 30, 2015, patented as U.S. Pat. No. 9,711,784 on Jul. 18, 2017, and entitled “ELECTRODE FABRICATION METHODS AND ASSOCIATED SYSTEMS AND ARTICLES”; U.S. Publication No. US-2014-0272565-A1 published on Sep. 18, 2014, filed as U.S. application Ser. No. 14/209,396 on Mar. 13, 2014, patented as U.S. Pat. No. 10,862, 105 on Dec. 8, 2020 and entitled “PROTECTED ELECTRODE STRUCTURES”; U.S. Publication No. US-2015-0010804-A1 published on Jan. 8, 2015, filed as U.S. application Ser. No. 14/323,269 on Jul. 3, 2014, patented as U.S. Pat. No. 9,994,959 on Jun. 12, 2018, and entitled “CERAMIC/POLYMER MATRIX FOR ELECTRODE PROTECTION IN ELECTROCHEMICAL CELLS, INCLUDING RECHARGEABLE LITHIUM BATTERIES”; U.S. Publication No. US-2015-0162586-A1 published on Jun. 11, 2015, filed as U.S. application Ser. No. 14/561,305 on Dec. 5, 2014, and entitled “NEW SEPARATOR”; U.S. Publication No. US-2015-0044517-A1 published on Feb. 12, 2015, filed as U.S. application Ser. No. 14/455,230 on Aug. 8, 2014, patented as U.S. Pat. No. 10,020,479 on Jul. 10, 2018, and entitled “SELF-HEALING ELECTRODE PROTECTION IN ELECTROCHEMICAL CELLS”; U.S. Publication No. US-2015-0236322-A1 published on Aug. 20, 2015, filed as U.S. application Ser. No. 14/184,037 on Feb. 19, 2014, patented as U.S. Pat. No. 10,490,796 on Nov. 26, 2019, and entitled “ELECTRODE PROTECTION USING ELECTROLYTE-INHIBITING ION CONDUCTOR”; U.S. Publication No. US-2015-0236320-A1 published on Aug. 20, 2015, filed as U.S. application Ser. No. 14/624/641 on Feb. 18, 2015, patented as U.S. Pat. No. 9,653,750 on May 16, 2017, and entitled “ELECTRODE PROTECTION USING A COMPOSITE COMPRISING AN ELECTROLYTE-INHIBITING ION CONDUCTOR”; U.S. Publication No. US-2016-0118638-A1 published on Apr. 28, 2016, filed as U.S. application Ser. No. 14/921,381 on Oct. 23, 2015, and entitled “COMPOSITIONS FOR USE AS PROTECTIVE LAYERS AND OTHER COMPONENTS IN ELECTROCHEMICAL CELLS”; U.S. Publication No. US-2016-0118651-A1 published on Apr. 28, 2016, filed as U.S. application Ser. No. 14/918,672 on Oct. 21, 2015, and entitled “ION-CONDUCTIVE COMPOSITE FOR ELECTROCHEMICAL CELLS”; U.S. Publication No. US-2016-0072132-A1 published on Mar. 10, 2016, filed as U.S. application Ser. No. 14/848/659 on Sep. 9, 2015, patented as U.S. Pat. No. 11,038,178 on Jun. 15, 2021 and entitled “PROTECTIVE LAYERS IN LITHIUM-ION ELECTROCHEMICAL CELLS AND ASSOCIATED ELECTRODES AND METHODS”; U.S. Publication No. US-2018-0138542-A1 published on May 17, 2018, filed as U.S. application Ser. No. 15/567,534 on Oct. 18, 2017, patented as U.S. Pat. No. 10,847,833 on Nov. 24, 2020 and entitled “GLASS-CERAMIC ELECTROLYTES FOR LITHIUM-SULFUR BATTERIES”; U.S. Publication No. US-2016-0344067-A1 published on Nov. 24, 2016, filed as U.S. application Ser. No. 15/160,191 on May 20, 2016, patented as U.S. Pat. No. 10,461,372 on Oct. 29, 2019, and entitled “PROTECTIVE LAYERS FOR ELECTROCHEMICAL CELLS”; U.S. Publication No. US-2020-0099108-A1 published on Mar. 26, 2020, filed as U.S. application Ser. No. 16/587,939 on Sep. 30, 2019, and entitled “PROTECTIVE LAYERS FOR ELECTROCHEMICAL CELLS”; U.S. Publication No. US-2017-0141385-A1 published on May 18, 2017, filed as U.S. application Ser. No. 15/343,890 on Nov. 4, 2016, and entitled “LAYER COMPOSITE AND ELECTRODE HAVING A SMOOTH SURFACE, AND ASSOCIATED METHODS”; U.S. Publication No. US-2017-0141442-A1 published on May 18, 2017, filed as U.S. application Ser. No. 15/349,140 on Nov. 11, 2016, and entitled “ADDITIVES FOR ELECTROCHEMICAL CELLS”; patented as U.S. Pat. No. 10/320,031 on Jun. 11, 2019, and entitled “ADDITIVES FOR ELECTROCHEMICAL CELLS”; U.S. Publication No. US-2017-0149086-A1 published on May 25, 2017, filed as U.S. application Ser. No. 15/343,635 on Nov. 4, 2016, patented as U.S. Pat. No. 9,825,328 on Nov. 21, 2017, and entitled “IONICALLY CONDUCTIVE COMPOUNDS AND RELATED USES”; U.S. Publication No. US-2018-0337406-A1 published on Nov. 22, 2018, filed as U.S. application Ser. No. 15/983,352 on May 18, 2018, patented as U.S. Pat. No. 10,868,306 on Dec. 15, 2020 and entitled “PASSIVATING AGENTS FOR ELECTROCHEMICAL CELLS”; U.S. Publication No. US-2018-0261820-A1 published on Sep. 13, 2018, filed as U.S. application Ser. No. 15/916,588 on Mar. 9, 2018, patented as U.S. Pat. No. 11,024,923 on Jun. 1, 2021 and entitled “ELECTROCHEMICAL CELLS COMPRISING SHORT-CIRCUIT RESISTANT ELECTRONICALLY INSULATING REGIONS”; U.S. Publication No. US-2020-0243824-A1 published on Jul. 30, 2020, filed as U.S. application Ser. No. 16/098,654 on Nov. 2, 2018, patented as U.S. Pat. No. 10,991,925 on Apr. 27, 2021 and entitled “COATINGS FOR COMPONENTS OF ELECTROCHEMICAL CELLS”; U.S. Publication No. US-2018-0351158-A1 published on Dec. 6, 2018, filed as U.S. application Ser. No. 15/983,363 on May 18, 2018, patented as U.S. Pat. No. 10,944,094 on Mar. 9, 2021 and entitled “PASSIVATING AGENTS FOR ELECTROCHEMICAL CELLS”; U.S. Publication No. US-2018-0277850-A1 published on Sep. 27, 2018, filed as U.S. application Ser. No. 15/923,342 on Mar. 16, 2018, and patented as U.S. Pat. No. 10,720,648 on Jul. 21, 2020, and entitled “ELECTRODE EDGE PROTECTION IN ELECTROCHEMICAL CELLS”; U.S. Publication No. US-2018-0358651-A1 published on Dec. 13, 2018, filed as U.S. application Ser. No. 16/002,097 on Jun. 7, 2018, and patented as U.S. Pat. No. 10,608,278 on Mar. 31, 2020, and entitled “IN SITU CURRENT COLLECTOR”; U.S. Publication No. US-2017-0338475-A1 published on Nov. 23, 2017, filed as U.S. application Ser. No. 15/599,595 on May 19, 2017, patented as U.S. Pat. No. 10,879,527 on Dec. 29, 2020, and entitled “PROTECTIVE LAYERS FOR ELECTRODES AND ELECTROCHEMICAL CELLS”; U.S. Publication No. US-2019-0088958-A1 published on Mar. 21, 2019, filed as U.S. application Ser. No. 16/124,384 on Sep. 7, 2018, and entitled “PROTECTIVE MEMBRANE FOR ELECTROCHEMICAL CELLS”; U.S. Publication No. US-2019-0348672-A1 published on Nov. 14, 2019, filed as U.S. application Ser. No. 16/470,708 on Jun. 18, 2019. patented as U.S. Pat. No. 11,183,690 on Nov. 23, 2021, and entitled “PROTECTIVE LAYERS COMPRISING METALS FOR ELECTROCHEMICAL CELLS”; U.S. Publication No. US-2017-0200975-A1 published Jul. 13, 2017, filed as U.S. application Ser. No. 15/429,439 on Feb. 10, 2017, and patented as U.S. Pat. No. 10,050,308 on Aug. 14, 2018, and entitled “LITHIUM-ION ELECTROCHEMICAL CELL, COMPONENTS THEREOF, AND METHODS OF MAKING AND USING SAME”; U.S. Publication No. US-2018-0351148-A1 published Dec. 6, 2018, filed as U.S. application Ser. No. 15/988, 182 on May 24, 2018, patented as U.S. Pat. No.11,251,501 on Feb. 15, 2022, and entitled “IONICALLY CONDUCTIVE COMPOUNDS AND RELATED USES”; U.S. Publication No. US-2018-0254516-A1 published Sep. 6, 2018, filed as U.S. application Ser. No. 15/765,362 on Apr. 2, 2018, and entitled “NON-AQUEOUS ELECTROLYTES FOR HIGH ENERGY LITHIUM-ION BATTERIES”; U.S. Publication No. US-2020-0044460-A1 published Feb. 6, 2020, filed as U.S. application Ser. No. 16,527,903 on Jul. 31, 2019, and entitled “MULTIPLEXED CHARGE DISCHARGE BATTERY MANAGEMENT SYSTEM”; U.S. Publication No. US-2020-0220146-A1 published Jul. 9, 2020, filed as U.S. application Ser. No. 16/724,586 on Dec. 23, 2019, and entitled “ISOLATABLE ELECTRODES AND ASSOCIATED ARTICLES AND METHODS”; U.S. Publication No. US-2020-0220149-A1 published Jul. 9, 2020, filed as U.S. application Ser. No. 16/724,596 on Dec. 23, 2019, and entitled “ELECTRODES, HEATERS, SENSORS, AND ASSOCIATED ARTICLES AND METHODS”; U.S. Publication No. US-2020-0220197-A1 published Jul. 9, 2020, filed as U.S. application Ser. No. 16/724,612 on Dec. 23, 2019, and entitled “FOLDED ELECTROCHEMICAL DEVICES AND ASSOCIATED METHODS AND SYSTEMS”, U.S. Publication No. US-2020-0373578-A1 published Nov. 26, 2020, filed as U.S. application Ser. No. 16/879,861 on May 21, 2020, and entitled “ELECTROCHEMICAL DEVICES INCLUDING POROUS LAYERS”, U.S. Publication No. US-2020-0373551-A1 published Nov. 26, 2020, filed as U.S. application Ser. No. 16/879,839 on May 21, 2020, and entitled “ELECTRICALLY COUPLED ELECTRODES, AND ASSOCIATED ARTICLES AND METHODS”, U.S. Publication No. US-2020-0395585-A1 published Dec. 17, 2020, filed as U.S. application Ser. No. 16/057,050 on Aug. 7, 2018, and entitled “LITHIUM-COATED SEPARATORS AND ELECTROCHEMICAL CELLS COMPRISING THE SAME”, U.S. Publication No. US-2021-0057753-A1 published Feb. 25, 2021, filed as U.S. application Ser. No. 16/994,006 on Aug. 14, 2020, and entitled “ELECTROCHEMICAL CELLS AND COMPONENTS COMPRISING THIOL GROUP-CONTAINING SPECIES”, U.S. Publication No. US-2021-0135297-A1 published on May 6, 2021, filed as U.S. application Ser. No. 16/670,905 on Oct. 31, 2019, and entitled SYSTEM AND METHOD FOR OPERATING A RECHARGEABLE ELECTROCHEMICAL CELL OR BATTERY″, U.S. Publication No. US-2021-0138673-A1 published on May 13, 2021, filed as U.S. application Ser. No. 17/089,092 on Nov. 4, 2020, and entitled “ELECTRODE CUTTING INSTRUMENT”, U.S. Publication No. US-2021-0135294-A1 published on May 6, 2021, filed as U.S. application Ser. No. 16/670,933 on Oct. 31, 2019, patented as U.S. Pat. No. 11,056,728 on Jul. 6, 2021 and entitled “SYSTEM AND METHOD FOR OPERATING A RECHARGEABLE ELECTROCHEMICAL CELL OR BATTERY”; U.S. Publication No. US-2021-0151839-A1 published on May 20, 2021, filed as U.S. application Ser. No. 16/952, 177 on Nov. 19, 2020, and entitled “BATTERIES, AND ASSOCIATED SYSTEMS AND METHODS”; U.S. Publication No. US-2021-0151830-A1 published on May 20, 2021, filed as U.S. application Ser. No. 16/952,235 on Nov. 19, 2020, and entitled “BATTERIES WITH COMPONENTS INCLUDING CARBON FIBER, AND ASSOCIATED SYSTEMS AND METHODS”; U.S. Publication No. US-2021-0151817-A1 published on May 20, 2021, filed as U.S. application Ser. No. 16/952,228 on Nov. 19, 2020, and entitled “BATTERY ALIGNMENT, AND ASSOCIATED SYSTEMS AND METHODS”; U.S. Publication No. US-2021-0151841-A1 published on May 20, 2021, filed as U.S. application Ser. No. 16/952,240 on Nov. 19, 2020, and entitled “SYSTEMS AND METHODS FOR APPLYING AND MAINTAINING COMPRESSION PRESSURE ON ELECTROCHEMICAL CELLS”; U.S. Publication No. US-2021-0151816-A1 published on May 20, 2021, filed as U.S. application Ser. No. 16/952,223 on Nov. 19, 2020, and entitled “THERMALLY INSULATING COMPRESSIBLE COMPONENTS FOR BATTERY PACKS”; U.S. Publication No. US-2021-0151840-A1 published on May 20, 2021, filed as U.S. application Ser. No. 16/952,187 on Nov. 19, 2020, and entitled “COMPRESSION SYSTEMS FOR BATTERIES”; U.S. Publication No. US-2021-0193984-A1 published on Jun. 24, 2021, filed as U.S. application Ser. No. 17/125,124 on Dec. 17, 2020, and entitled “SYSTEMS AND METHODS FOR FABRICATING LITHIUM METAL ELECTRODES”; U.S. Publication No. US-2021-0193985-A1 published on Jun. 24, 2021, filed as U.S. application Ser. No. 17/125,110 on Dec. 17, 2020, and entitled “LITHIUM METAL ELECTRODES AND METHODS”; U.S. Publication No. US-2021-0193996-A1 published on Jun. 24, 2021, filed as U.S. application Ser. No. 17/125,070 on Dec. 17, 2020, and entitled “LITHIUM METAL ELECTRODES”; U.S. Publication No. US-2021-0194069-A1 published on Jun. 24, 2021, filed as U.S. application Ser. No. 17/126,390 on Dec. 18, 2020, and entitled “SYSTEMS AND METHODS FOR PROVIDING, ASSEMBLING, AND MANAGING INTEGRATED POWER BUS FOR RECHARGEABLE ELECTROCHEMICAL CELL OR BATTERY”; U.S. Publication No. US-2021-0218243 published on Jul. 15, 2021, filed as U.S. application Ser. No. 17/126,424 on Dec. 18, 2020, and entitled “SYSTEMS AND METHODS FOR PROTECTING A CIRCUIT, RECHARGEABLE ELECTROCHEMICAL CELL, OR BATTERY”; U.S. Publication No. 2022-0069593 published on Mar. 3, 2022, filed as U.S. application Ser. No. 17/463,467 filed on Aug. 31, 2021, and entitled “Multiplexed Battery Management System”; U.S. Publication No. 2022-0048121 published on Feb. 17, 2022, filed as U.S. application Ser. No. 17/397,114 filed on Aug. 9, 2021, and entitled “Ultrasonic Blade for Cutting a Metal”, U.S. Publication No. 2022-0115715 published on Apr. 14, 2022, filed as U.S. application Ser. No. 17/479,299 filed on Sep. 20, 2021 and entitled “Electrolytes for Reduced Gassing”.

The following examples are intended to illustrate certain embodiments of the present disclosure, but do not exemplify the full scope of the disclosure.

### Example 1

This example describes the production of non-limiting electrochemical cells tested in later examples. The electrochemical cells were all small pouch cells comprising a NCM811 cathode, a 50 micron thick lithium foil anode, and a 9 micron thick polyolefin separator. The electrochemical cells each had an active area of 99.4 cm² and contained 0.5 mL of electrolyte. The electrolytes each comprised lithium salts (LiPF₆ or LiFSI) and organic solvents comprising linear carbonates (e.g., dimethyl carbonate) and/or partially fluorinated cyclic esters of carbonic acid (e.g., fluoroethylene carbonate).

Poly(phosphate sulfate)s (specifically: potassium pyrosulfate, K₂S₂O₇; or potassium pyrophosphate, K₄P₂O₇) were included in the cells as additives included as a fine suspension in the electrolyte. Each cell was filled with electrolyte and temporarily sealed, in order to allow the poly(phosphate sulfate)s to treat the electrodes. Temporarily sealed cells with and without additives (e.g., control cells) were stored at a temperature of 72° C. for 60 hours.

After storage, the cells were subjected to 12 kg/cm² pressure and subjected to 3 charge-discharge cycles at a charge current of 15 mA to 4.3 V and discharge current of 60 mA to 3.2 V, during the formation stage of the electrochemical cells. Finally, the electrochemical cells were vented and resealed, producing final electrochemical cells used during subsequent testing.

This example demonstrates that the methods described herein may be used to produce electrochemical cells comprising poly(phosphate sulfate)s. The following examples demonstrate the advantages that can be associated with such electrochemical cells.

### Example 2

Non-limiting electrochemical cells prepared as described in Example 1 were cycled under an anisotropic pressure of 12 kg/cm², and gas generation experiments were performed. Gas generations tests were performed at elevated temperatures, to accelerate the release rate of gas, relative to the release rate of the gas under ordinary operating temperatures of the electrochemical cells. The high temperature gas generation test was performed in three steps. First, electrochemical cell volumes (V₁) were measured by water displacement at 20° C., before exposure of the electrochemical cell to high temperatures. Electrochemical cells were then charged at 60 mAh to 4.3 V, and fully charged cells were stored at elevated temperature for an appropriate time period. Finally, electrochemical cells were cooled to 20° C. and the new cell volume (V₂) was measured. Cell volume increase was calculated as V₂−V₁, and was attributed to the volume of gas generated during high temperature storage (72° C. for 60 h). Five replicates were performed for each electrochemical cell, and the generated gas volume calculated as average value for the gas generation of the 5 cells.

Table 1 describes the results for a variety of non-limiting electrochemical cells, and includes specific compositional and experimental details for each type of electrochemical cell. As shown in Table 1, the addition of the poly(phosphate sulfate) to the electrolyte generally reduced the amount of gas produced within the electrochemical cells by 50% to 75% (relative to the amount of gas produced in an otherwise identical control cell), and the effect was stronger when poly(phosphate sulfate)s represented a greater proportion of the electrolyte. These examples clearly demonstrate that the treatment of the electrochemical cells with poly(phosphate sulfate)s substantially reduced gas generation.

TABLE 1
Gas generation data for electrochemical cells comprising poly(phosphate sulfate)s
as electrolyte additives, and control cells without poly(phosphate sulfate)s.

| | | Additive, wt % | | | |
|---|---|---|---|---|---|
| Sample: | Additive | of Electrolyte | Gas, mL | Solvent | Salt |
| Control 1 | No additive | N/A | 1.58 | linear carbonate + partially | LiPF₆ |
| | | | | fluorinated cyclic carbonate | |
| Control 2 | No additive | N/A | 0.92 | linear carbonate + partially | LiFSI |
| | | | | fluorinated cyclic carbonate | |
| Control 3 | No additive | N/A | 1.38 | linear trifluoroethyl methyl | LIFSI |
| | | | | carbonate, partially | |
| | | | | fluorinated cyclic carbonate | |
| Cell 1 | K₄P₂O₇ | 1 | 1.04 | linear carbonate + partially | LiPF₆ |
| | | | | fluorinated cyclic carbonate | |
| Cell 2 | K₄P₂O₇ | 2 | 0.95 | linear carbonate + partially | LiPF₆ |
| | | | | fluorinated cyclic carbonate | |
| Cell 3 | K₄P₂O₇ | 4 | 0.46 | linear carbonate + partially | LiPF₆ |
| | | | | fluorinated cyclic carbonate | |
| Cell 4 | K₄S₂O₇ | 4 | 0.38 | linear carbonate + partially | LiPF₆ |
| | | | | fluorinated cyclic carbonate | |
| Cell 5 | K₄S₂O₇ | 4 | 0.59 | linear carbonate + partially | LiFSI |
| | | | | fluorinated cyclic carbonate | |
| Cell 6 | K₄S₂O₇ | 4 | 0.49 | linear trifluoroethyl methyl | LiFSI |
| | | | | carbonate, partially | |
| | | | | fluorinated cyclic carbonate | |

### Example 3

This experiment illustrates that the gas reduction additives did not detrimentally affect the cycle life of electrochemical cells. Gas generation experiments were performed as described in Example 2, above, except that electrochemical cells were heated to a temperature of 90° C. for a period of 72 h. For determining cycle life, cells were charged at 60 mA to 4.3 V and discharged at 240 mA to 3.2 V. All cells had an initial discharge capacity of 160 mAh. The electrochemical cells were cycled until they reached a cutoff discharge capacity of 125 mAh (˜78%), and this cutoff was used to establish the cycle-life of the cells. Five replicates of each electrochemical cell were performed, and the reported cycle life was calculated as the average cycle life for each electrochemical cell. No individual electrochemical cell was used for both cycle life determination and gas generation, although identical cell designs were used for the two experiments. Table 2 presents the cycle life and gas generation of electrochemical cells with and without a poly(phosphate sulfate) additive. As shown, the reduction in gas generation did not have a negative impact on cycle life, indicating that the improved safety of electrochemical cells treated with poly(phosphate sulfate)s does not come at the cost of cycle-life reduction.

TABLE 2
Gas generation and cycle life data for an electrochemical cell comprising
a poly(phosphate sulfate) as an electrolyte additive.

| | | Additive, wt % | | |
|---|---|---|---|---|
| Sample: | Additive | of Electrolyte | Gas, mL | Cycle Life |
| Control 4 | No additive | N/A | 4.23 | 1103 |
| Cell 7 | K₄S₂O₇ | 8 | 2.44 | 1117 |

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt %” is an abbreviation of weight percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended. i.e., to mean including but not limited to. Only the transitional phrases “consisting of” and “consisting essentially of” shall be closed or semi-closed transitional phrases, respectively. as set forth in the United States Patent Office Manual of Patent Examining Procedures, Section 2111.03.

1. An electrochemical cell, comprising:
an electrode comprising lithium; and
an electrolyte,
wherein the electrolyte comprises an organic solvent, a lithium salt, and a compound having a formula (I): 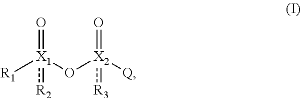
wherein X₁ [symbol] and X₂ [symbol] are each independently S [symbol] or P [symbol] ,
wherein R₁ is OH, O⁻, or OM, where M is Li⁺, Na⁺, or K⁺,
wherein, when X₁ and/or X₂ is sulfur, R₂ and/or R₃ is O, respectively,
wherein, when X₁ and/or X₂ is phosphorus, R₂ and/or R₃ is each independently OH, O⁻, or OM, where M is Li⁺, Na⁺, or K⁺, respectively, and
wherein Q is OH, O⁻, OM, where M is Li⁺, Na⁺, or K⁺, or 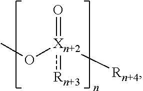
wherein n is an integer greater than or equal to 1 and less than or equal to 10,
wherein each Xₙ₊₂ is independently sulfur or phosphorous,
wherein when Xₙ₊₂ is sulfur, Xₙ₊₂ [symbol] is a double bond and Rₙ₊₃ is O,
wherein when Xₙ₊₂ is phosphorus, Xₙ₊₂ [symbol] is a single bond and each Rₙ₊₃ is independently OH, O⁻, or OM, where M is Li⁺, Na⁺, or K⁺, and
wherein Rₙ₊₄ is independently OH, O⁻, or OM, where M is Li⁺, Na⁺, or K⁺.

2. A method of treating an electrode of an electrochemical cell, the method comprising:
contacting an electrode comprising lithium with a compound present in the electrochemical cell, wherein the compound has a formula (I): 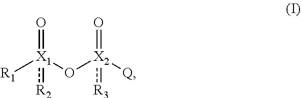
wherein X₁ [symbol] and X₂ [symbol] are each independently S [symbol] or P [symbol] ,
wherein R₁ is OH, O⁻, or OM, where M is Li⁺, Na⁺, or K⁺,
wherein, when X₁ and/or X₂ is sulfur, R₂ and/or R₃ is O, respectively,
wherein, when X₁ and/or X₂ is phosphorus, R₂ and/or R₃ is each independently OH, O⁻, or OM, where M is Li⁺, Na⁺, or K⁺, respectively, and
wherein Q is OH, O⁻, OM, where M is Li⁺, Na⁺, or K⁺, or 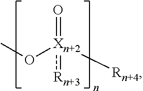
wherein n is an integer greater than or equal to 1 and less than or equal to 10,
wherein each Xₙ₊₂ is independently sulfur or phosphorous,
wherein when Xₙ₊₂ is sulfur, Xₙ₊₂ [symbol] is a double bond and Rₙ₊₃ is O,
wherein when Xₙ₊₂ is phosphorus, Xₙ₊₂ [symbol] is a single bond and each Rₙ₊₃ is independently OH, O⁻, or OM, where M is Li⁺, Na⁺, or K⁺, and
wherein Rₙ₊₄ is independently OH, O⁻, or OM, where M is Li⁺, Na⁺, or K⁺,
the method further comprising releasing a gas produced by the contact between the electrode and the compound.

3. (canceled)

4. A method as in claim 2, further comprising venting the electrochemical cell to release the gas produced by the contact between the electrode and the compound prior to cycling of the electrochemical cell.

5-6. (canceled)

7. An electrochemical cell as in claim 1, wherein the electrode is a lithium metal anode.

8-9. (canceled)

10. A method as in claim 2, wherein the electrochemical cell comprises an electrolyte that comprises an organic solvent and/or a lithium salt.

11. An electrochemical cell as in claim 1, wherein the lithium salt comprises LiSCN; LiBr; LiI; LiClO₄; LiAsF₆; LiSO₃CF₃; LiSO₃CH₃; LiBF₄; LiB(Ph)₄; LiPF₆; LiCF₃SO₃; LiC(SO₂CF₃)₃; LiN(SO₂CF₃)₂); LiC(CₙF₂ₙ₊₁SO₂)₃, wherein n is an integer in the range of from 1 to 20; LiN(SO₂F)₂; LiAlF₄; LiNO₃; Li₂SiF₆; LiSbF₆; LiAlCl₄; LiBF₂(C₂O₄); LiBOB; LiFSI; a salt of the general formula (CₙF₂ₙ₊₁SO₂)ₘXLi with n being an integer in the range of from 1 to 20; m being 1 when X is selected from oxygen or sulfur, m being 2 when X is selected from nitrogen or phosphorus; and m being 3 when X is selected from carbon or silicium; and Li₂Sₓ.

12. An electrochemical cell as in claim 1, wherein the organic solvent comprises at least one of a cyclic and non-cyclic acetal, an organic carbonate, an organic amide, a cyclic ether, a non-cyclic ether, and/or at least one of an organic acid ester and an inorganic acid ester.

13. An electrochemical cell as in claim 1, wherein the carbonate is a linear carbonate.

14. An electrochemical cell as in claim 1, wherein the carbonate is a cyclic carbonate.

15. An electrochemical cell as in claim 13, wherein the linear carbonate is dimethyl carbonate, diethyl carbonate, or ethylmethyl carbonate.

16. An electrochemical cell as in claim 14, wherein the cyclic carbonate is fluoroethylene carbonate.

17. An electrode, comprising:
a compound having a formula (I): 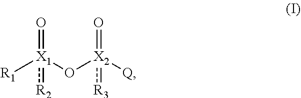
wherein X₁ [symbol] and X₂ [symbol] are each independently S [symbol] or P [symbol] ,
wherein R₁ is OH, O⁻, or OM, where M is Li⁺, Na⁺, or K⁺,
wherein, when X₁ and/or X₂ is sulfur, R₂ and/or R₃ is O, respectively,
wherein, when X₁ and/or X₂ is phosphorus, R₂ and/or R₃ is each independently OH, O⁻, or OM, where M is Li⁺, Na⁺, or K⁺, respectively, and
wherein Q is OH, O⁻, OM, where M is Li⁺, Na⁺, or K⁺, or 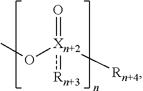
wherein n is an integer greater than or equal to 1 and less than or equal to 10,
wherein each Xₙ₊₂ is independently sulfur or phosphorous,
wherein when Xₙ₊₂ is sulfur, Xₙ₊₂ [symbol] is a double bond and Rₙ₊₃ is O,
wherein when Xₙ₊₂ is phosphorus, Xₙ₊₂ [symbol] is a single bond and each Rₙ₊₃ is independently OH, O⁻, or OM, where M is Li⁺, Na⁺, or K⁺,
wherein Rₙ₊₄ is independently OH, O⁻, or OM, where M is Li⁺, Na⁺, or K⁺, and
wherein the electrode comprises lithium.

18. (canceled)

19. An electrochemical cell as in claim 1, wherein X₁ and X₂ are both sulfur.

20. An electrochemical cell as in claim 1, wherein X₁ and X₂ are both phosphorous.

21. An electrochemical cell as in claim 1, wherein the compound is a salt.

22. An electrochemical cell as in claim 1, wherein the compound is a polysulfate or a polyphosphate salt.

23-24. (canceled)

25. An electrochemical cell as in claim 1, wherein the compound is potassium pyrosulfate or potassium pyrophosphate.

26. (canceled)

27. An electrochemical cell as in claim 1, wherein the compound is suspended in the electrolyte.

28. (canceled)

29. An electrochemical cell as in claim 1; wherein the first electrode comprises: LiₓCoO₂; LiₓNiO₂; LiₓMnO₂; LiₓMn₂O₄; LiₓCoPO₄; LiₓMnPO₄; LiCoO₂; LiCoₓNi₍₁₋ₓ₎O₂, where x is between approximately 0.05 and 0.8; LiCoₓNi_{y}Mn_{1-x-y)}, where x and y are each independent and less than or equal to 1; LiMn₂O₄; LiFePO₄; LiMnPO₄; LiₓNiPO₄ where x is less than or equal to 1; and/or LiMnₓNi_{y}O₄, where x+y=2; LiNiₓCo_{y}Al_{z}O₂, where x+y+z=1.

30. An electrochemical cell as in claim 1, wherein the electrochemical cell is part of a battery.

31. (canceled)
